(19) United States
(12) Patent Application Publication
(10) Pub. No.: US 2020/0311953 A1
(43) Pub. Date: Oct. 1, 2020

(54) MULTI-CAMERA KIOSK

(71) Applicant: On Time Staffing Inc., Golden Valley, MN (US)

(72) Inventor: Roman Olshansky, Plymouth, MN (US)

(21) Appl. No.: 16/828,578

(22) Filed: Mar. 24, 2020

Related U.S. Application Data
(60) Provisional application No. 62/824,755, filed on Mar. 27, 2019.

(51) Int. Cl. G06T 7/292

(52) U.S. Cl. CPC G06T 7/292; G06T 2207/30244

(57) ABSTRACT

Some examples provide a kiosk for recording audio and video of an individual and producing audiovisual files from the recorded data. The kiosk can be an enclosed booth with a plurality of recording devices. For example, the kiosk can include multiple cameras, microphones, and sensors for capturing video, audio, movement, and other behavioral data of an individual. The video and audio data can be combined to create audiovisual files for a video interview. Behavioral data can be captured by the sensors in the kiosk and can be used to supplement the video interview, allowing the system to analyze subtle factors of the candidate's abilities and temperament that are not immediately apparent from viewing the individual in the video and listening to the audio.

### CLAIM OF PRIORITY

This application claims the benefit of U.S. Provisional Application No. 62/824,755, filed Mar. 27, 2019, the content of which is herein incorporated by reference in its entirety.

### FIELD OF THE TECHNOLOGY

Various examples relate to a video booth or kiosk including a plurality of video cameras. The booth or kiosk can be used to record the motions, movements, facial expressions, and other behaviors of an individual within the kiosk. More particularly, some examples relate to a kiosk having audio microphones, multiple video cameras at approximate facial heights when the individual is seated, and multiple depth sensors arranged at different heights and along different walls of the kiosk.

### BACKGROUND

A video kiosk can be used for a variety of purposes. For example, a video kiosk can be used to record brief interactions among friends for entertainment in the same manner as novelty photo booths. However, video and audio data is not always captured to the fullest extent possible. Further, additional useful data can also be missed.

### SUMMARY

Various examples provide a kiosk comprising a booth and an edge server. The booth comprises an enclosing wall forming a perimeter of the booth and defining a booth interior. The enclosing wall extends between a bottom of the enclosing wall and a top of the enclosing wall. The enclosing wall comprises a front wall, a back wall, a first side wall, and a second side wall. The front wall is substantially parallel with the back wall, and the first side wall is substantially parallel with the second side wall. The first side wall and the second side wall extend from the front wall to the back wall. The enclosing wall has a height from the bottom of the enclosing wall to the top of the enclosing wall of at least 7 feet (2.1 meters) and not more than 13 feet (4.0 meters). The perimeter is at least 14 feet (4.3 meters) and not more than 80 feet (24.4 meters). The booth comprises a first camera, a second camera, and a third camera for taking video images. Each of the cameras can be aimed proximally toward the booth interior. The first camera, the second camera, and the third camera are disposed at a height of at least 30 inches (76 centimeters) and not more than 70 inches (178 centimeters) from the bottom of the enclosing wall. The first camera, the second camera, and the third camera are disposed adjacent to the front wall. The booth further includes a first microphone for receiving sound in the booth interior. The microphone is disposed within the booth interior. The booth further includes a first depth sensor and a second depth sensor for capturing behavioral data. The first depth sensor is disposed at a height of at least 20 inches (51 centimeters) and not more than 45 inches (114 centimeters) from the bottom of the enclosing wall. The second depth sensor is disposed at a height of at least 30 inches (76 centimeters) and not more than 50 inches (127 centimeters) from the bottom of the enclosing wall. The first depth sensor and the second depth sensor are aimed proximally toward the booth interior. The first depth sensor is mounted on the first side wall or on the second side wall, and the second depth sensor is mounted on the back wall. The booth further includes a first user interface shows a video of a user, prompts the user to answer interview questions, or prompts the user to demonstrate a skill. The edge server connected to the first camera, the second camera, the third camera, the first depth sensor, the second depth sensor, the first microphone, and the first user interface.

In some examples, the first camera, the second camera, and the third camera are mounted to the front wall, or wherein the first camera is mounted to the first side wall, the second camera is mounted to the front wall, and the third camera is mounted to the second side wall.

In some examples, the booth further comprises a fourth camera disposed adjacent to or in the corner of the front wall and the second side wall. The first side wall comprises a door. The fourth camera is disposed at a height of at least 50 inches (127 centimeters) from the bottom of the enclosing wall.

In some examples, the booth further comprises a fifth camera disposed adjacent to or in the corner of the back wall and the second side wall, wherein the fifth camera is disposed at a height of at least 50 inches (127 centimeters) from the bottom of the enclosing wall.

In some examples, the booth further comprises a second user interface and a third user interface, wherein the second user interface is mounted on a first arm extending from the second side wall and the third user interface is mounted on a second arm extending from the first side wall.

In some examples, the first user interface is configured to display an image of the user, the second user interface is configured to receive input for the user in response to a prompt provided by the third user interface, and the third user interface is configured to provide a prompt to the user.

In some examples, the kiosk does not include a roof connected to the enclosing wall.

In some examples, the booth further comprises a third depth sensor for capturing behavioral data, wherein the third depth sensor is mounted on the first side wall or the second side wall opposite from the first depth sensor; wherein the third depth sensor is disposed at a height of at least 30 inches (76 centimeters) and not more than 50 inches (127 centimeters) from the bottom of the enclosing wall; wherein the third depth sensor is aimed proximally toward the booth interior; wherein the edge server is connected to the third depth sensor.

Various examples provide a kiosk comprising a booth and an edge server. The booth comprises an enclosing wall forming a perimeter of the booth and defining a booth interior; wherein the enclosing wall extends between a bottom of the enclosing wall and a top of the closing wall; wherein the enclosing wall has a height from the bottom of the enclosing wall to the top of the enclosing wall of at least 7 feet (2.1 meters) and not more than 13 feet (4.0 meters); and wherein the perimeter is at least 14 feet (4.3 meters) and not more than 80 feet (24.4 meters). The booth further comprising a first camera and a second camera for taking video images, each of the cameras aimed proximally toward the booth interior; wherein the first camera and the second camera are disposed at a height of at least 30 inches (76 centimeters) and not more than 70 inches (178 centimeters) from the bottom of the enclosing wall; and wherein the first camera and second camera are disposed on the same portion of the enclosing wall. The booth further comprising a first microphone for receiving sound in the booth interior. The booth further comprising at least one depth sensor for capturing behavioral data, wherein the at least one depth sensor is disposed at a height of at least 20 inches (51 centimeters) and not more than 50 inches (127 centimeters) from the bottom of the enclosing wall; and wherein the at least one depth sensor is aimed proximally toward the booth interior. The booth further comprises a user interface that shows a video of a user, prompts the user to answer interview questions, or prompts the user demonstrate a skill, and wherein the user interface comprises a third camera. The edge server connected to the first camera, the second camera, the depth sensor, the first microphone, and the user interface.

In some examples, the enclosing wall comprises an extruded metal frame and polycarbonate panels.

In some examples, the depth sensor comprises a stereoscopic depth sensor.

In some examples, the kiosk further comprises an occupancy sensor disposed in a corner of the booth at a height of at least 72 inches (183 centimeters) from the bottom of the enclosing wall.

In some examples, the occupancy sensor comprises an infrared camera.

In some examples, the kiosk further comprises a fourth camera for taking video images, the fourth camera aimed proximally toward the booth interior.

In some examples, the fourth camera is disposed at a height of at least 30 inches (76 centimeters) and not more than 70 inches (178 centimeters) from the bottom of the enclosing wall; wherein the fourth camera is disposed on the same portion of the enclosing wall as the first camera and the second camera.

Various embodiments provide a kiosk comprising a booth, an edge server, and computer instructions. The booth comprises an enclosing wall forming a perimeter of the booth and defining a booth interior, wherein the enclosing wall extends between a bottom of the enclosing wall and a top of the enclosing wall; a first camera and a second camera for taking video images, each of the cameras aimed proximally toward a user in the booth interior; a first microphone for receiving sound in the booth interior; at least one depth sensor for capturing behavioral data, and a user interface that prompts the user to answer interview questions or demonstrate a skill. The kiosk further comprising an edge server connected to the first camera, the second camera, the depth sensor, and the first microphone. The edge server comprising a time counter providing a timeline associated with the capturing of video images from the first and second cameras, the capturing of behavioral data from the depth sensor, and the capturing of audio from the first microphone, wherein the timeline enables a time synchronization of the video images, the behavioral data, and the audio; and a non-transitory computer memory and a computer processor in data communication with the first and second cameras and the first microphone. The kiosk further comprising computer instructions stored on the memory for instructing the processor to perform the steps of: capturing first video input of the user from the first camera, capturing second video input of the user from the second camera, capturing behavioral data input from the depth sensor, capturing audio input of the user from the first microphone, aligning the first video input, the second video input, the behavioral data, and the audio input with the time counter, extracting behavioral data from the behavioral data input, and associating a prompted question or demonstration of a skill with the extracted behavioral data.

In some examples, the computer instructions stored on the memory for instructing the processor to further perform the steps of automatically concatenating a portion of the first captured video data and a portion of the second captured video data, and automatically saving the concatenated video data with the audio data as a single audiovisual file.

In various examples, the kiosk further comprises a second microphone for capturing audio housed in the enclosed booth, wherein the edge server is connected to the second microphone, and the time counter provides a timeline further associated with the second microphone. The computer instructions stored on the memory for instructing the processor to further perform the steps of analyzing audio from the first microphone and audio from the second microphone to determine the highest quality audio data and automatically saving the concatenated video data with the highest quality audio data as a single audiovisual file.

In some examples, the highest quality audio data is determined by determining which audio has the highest volume.

In some examples, the highest quality audio data is determined by determining which audio has the lowest signal to noise ratio.

In some examples, the single audiovisual file comprises video input from the first camera when audio from the first microphone is used and video input from the second camera when audio from the second microphone is used.

In some examples, the kiosk further comprises computer instructions stored on the memory for instructing the processor to, when associating the prompted question or demonstration of the skill with extracted behavioral data, process the audio data with speech to text analysis and compare a subject matter in the audio data to a behavioral characteristic.

In some examples, the behavioral characteristic includes a characteristic selected from the group consisting of sincerity, empathy, and comfort.

In some examples, the depth sensor includes a sensor selected from the group consisting of an optical sensor, an infrared sensor, and a laser sensor.

In some examples, the kiosk further comprises a second user interface separate from the first user interface, wherein the second user interface is configured for the user to input data in response to the prompt to demonstrate a skill.

In some examples, the second user interface is disposed opposite from or adjacent to the first user interface.

In some examples, the computer instructions stored on the memory for instructing the processor to further perform the step of aligning the input from the second user interface with the first video input, the second video input, the behavioral data, and the audio input with the time counter.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

FIG. 1 is a perspective view of a multi-camera kiosk according to some examples.

FIG. 2 is a schematic representation of depth sensors, visual cameras, and audio recording sensors linked with one or more servers according to some examples.

FIG. 3 is a schematic representation of depth sensors, visual cameras, and audio recording sensors linked with one or more servers according to some examples.

FIG. 4 is a schematic side view of a cross-section of the kiosk according to some examples.

FIG. 5 is a schematic top view of a cross-section of a kiosk according to some examples.

FIG. 6 is a schematic top view of a cross-section of a kiosk according to some examples.

FIG. 7 is a schematic top view of a kiosk according to some examples.

FIG. 8 is a schematic top view of a cross-section of a kiosk according to some examples.

FIG. 9 is a schematic top view of a cross-section of a kiosk according to some examples.

FIG. 10 is a perspective view of a portion of the kiosk according to some examples.

FIG. 11 is a perspective view of a portion of the kiosk according to some examples.

FIG. 12 is a perspective view of a portion of the kiosk according to some examples.

FIG. 13 is a perspective view of a portion of the kiosk according to some examples.

FIG. 14 is a perspective view of a portion of the kiosk according to some examples.

FIG. 15 is a perspective view of a portion of the kiosk according to some examples.

FIG. 16 is a schematic view of a kiosk system according to some examples.

FIG. 17 illustrates an example of multiple video inputs.

FIG. 18 is a graph of decibel level versus time for an audio input according to some examples.

FIG. 19 visually illustrates a method of automatically concatenating audiovisual clips into an audiovisual file according to some examples.

FIG. 20 visually illustrates a method of removing pauses from audio and video inputs and automatically concatenating audiovisual clips into an audiovisual file according to some examples.

FIG. 21 visually illustrates a method of automatically concatenating audiovisual clips into an audiovisual file in response to an event according to some examples.

FIG. 22 is a schematic view of a system for a network of video interview kiosks according to some examples.

FIG. 23 is a schematic view of a candidate database server system according to some examples.

FIG. 24 is a schematic view of a candidate database according to some examples.

FIG. 25A is a flow chart for a method of building an empathy score model according to some examples.

FIG. 25B is a flow chart for a method of applying an empathy score model according to some examples.

FIG. 26 is a flow chart of a method for selecting an interview file to be displayed according to some examples.

FIG. 27 is a schematic illustrating one example of a system for recording behavioral data input.

FIG. 28A shows a first image of a candidate being recorded by the sensors in FIG. 27.

FIG. 28B shows a second image of a candidate being recorded by the sensors in FIG. 27.

FIG. 28C shows a third image of a candidate being recorded by the sensors in FIG. 27.

FIG. 29A represents the output of a calculation described in relation to FIG. 28A.

FIG. 29B represents the output of a calculation described in relation to FIG. 28B.

FIG. 29C represents the output of a calculation described in relation to FIG. 28C.

FIG. 30A shows a first example of a graph that can be created from behavioral data gathered during a candidate video interview.

FIG. 30B shows a second example of a graph that can be created from behavioral data gathered during a candidate video interview.

FIG. 31 is a floor plan view for a multi-camera kiosk according to some examples.

FIG. 32 is a cutaway view of the kiosk of FIG. 31 according to some examples.

FIG. 33 is a floor plan view of an alternative example of a multi-camera kiosk.

### DETAILED DESCRIPTION

The present disclosure relates to a kiosk for recording audio and video of an individual and producing audiovisual files from the recorded data. The kiosk can be an enclosed booth with a plurality of recording devices. For example, the kiosk can include multiple cameras, microphones, and sensors for capturing video, audio, movement and other behavioral data of an individual. The video and audio data can be combined to create audiovisual files for a video interview. Behavioral data can be captured by the sensors in the kiosk and can be used to supplement the video interview, allowing the system to analyze subtle factors of the candidate's abilities and temperament that are not immediately apparent from viewing the individual in the video and listening to the audio.

The system can be used for recording a person who is speaking, such as in a video interview. Although the system and kiosk will be described in the context of a video interview, other uses are contemplated and are within the scope of the technology. For example, the system could be used to record educational videos, entertaining or informative speaking, medical consultations, or other situations in which an individual is being recorded with video and audio.

Some examples of the technology provide an enclosed soundproof booth. The booth can contain one or more studio spaces for recording a video interview. Multiple cameras inside of the studio capture video images of an individual from multiple camera angles. A microphone captures audio of the interview. A system clock can be provided to synchronize the audio and video images. Additional sensors can be provided to extract behavioral data of the individual during the video interview. For example, a depth sensor, such as an infrared sensor or a stereoscopic optical sensor, can be used to sense data corresponding to the individual's body movements, gestures, or facial expressions. The behavioral data can be analyzed to determine additional information about the candidate's suitability for particular employment. A microphone can provide behavioral data input, and the speech recorded using the microphone can be analyzed to extract behavioral data, such as vocal pitch and vocal tone, word patterns, word frequencies, vocabulary, and other information conveyed in the speaker's voice and speech. The behavioral data can be combined with the video interview for a particular candidate and stored in a candidate database. The candidate database can store profiles for many different job candidates, allowing hiring managers to easily access a large amount of information about a large pool of candidates.

In some examples, the kiosk is provided with a local edge server for processing the inputs from the camera, microphone, and sensors. The edge server includes a processor, memory, and a network connection device for communication with a remote database server. This setup allows the system to produce audiovisual interview files and a candidate evaluation as soon as the candidate has finished recording the interview. In some examples, processing of the data input occurs at the local edge server. This includes turning raw video data and audio data into audiovisual files, and extracting behavior data from the raw sensor data received at the kiosk. In some examples, the system minimizes the load on the communication network by minimizing the amount of data that must be transferred from the local edge server to the remote server. Processing this information locally, instead of sending large amounts of data to a remote network to be processed, allows for efficient use of the network connection. The automated nature of the process used to produce audiovisual interview files and condense the received data inputs quickly reduces the amount of computer storage space required to store a rich data set related to each candidate.

In some examples, two or more cameras are provided to capture video images of the individual during the video interview. In some examples, three cameras are provided: a right side camera, a left side camera, and a center camera. In some examples, each camera has a sensor capable of recording body movement, gestures, or facial expression. In some examples, the sensors can be depth sensors such as infrared sensors or stereoscopic optical sensors. A system with two or more depth sensors, such as three depth sensors, can be used to generate 3D models of the individual's movement. For example, the system can analyze the individual's body posture by compiling data from two or more sensors. This body posture data can then be used to extrapolate information about the individual's emotional state during the video interview, such as whether the individual was calm or nervous, or whether the individual was speaking passionately about a particular subject.

In another aspect, the system can include multiple kiosks at different locations remote from each other. Each kiosk can have an edge server, and each edge server can be in communication with a remote candidate database server. The kiosks at the different locations can be used to create video interviews for multiple job candidates. These video interviews can then be sent from the multiple kiosks to the remote candidate database to be stored for later retrieval. Having a separate edge server at each kiosk location allows for faster processing, as the kiosks can upload to a database or cloud storage which allows the files to be queried, making the latest content available more quickly than in traditional video production systems.

Users at remote locations can request to view information for one or more job candidates. Users can access this information from multiple channels, including personal computers, laptops, tablet computers, and smart phones. For example, a hiring manager can request to view video interviews for one or more candidates for a particular job opening. The candidate database server can use a scoring system to automatically determine which candidates' video interviews to send to the hiring manager for review. This automatic selection process can be based in part on analyzed behavioral data that was recorded during the candidate's video interview.

In another aspect, the kiosk can be provided in a number of physical shapes. In some examples, the kiosk can be a rectangle, square, cylinder, polygon, or star-like shape. In some examples, the kiosk has one studio for video recording. In alternative examples, the kiosk can have two, three, or more individual studios separated by soundproof walls. A multi-studio kiosk can efficiently allow multiple candidates to be interviewed simultaneously. In some examples, the kiosk includes soundproofing in the walls of the kiosk, allowing the kiosk to be placed in a setting with considerable exterior noise, such as in a shopping center. The kiosk can be provided with one or more sliding doors. The sliding doors can be shaped to follow the contour of the sidewalls of the kiosk.

In another aspect, the technology provides a mobile kiosk with multiple cameras, a microphone, and one or more sensors for receiving behavioral data. The kiosk can be quickly constructed in a small or large setting, such as a mall or airport, to conveniently attract job candidates to record video interviews.

Combining Video and Audio Files

The disclosed technology can be used with a system and method for producing audiovisual files containing video that automatically cuts between video footage from multiple cameras. The multiple cameras can be arranged during recording such that they each focus on a subject from a different camera angle, providing multiple viewpoints of the subject. The system can be used for recording a person who is speaking, such as in a video interview. Although the system will be described in the context of a video interview, other uses are contemplated and are within the scope of the technology. For example, the system could be used to record educational videos, entertaining or informative speaking, or other situations in which an individual is being recorded with video and audio.

Some implementations provide a kiosk or booth that houses multiple cameras and a microphone. The cameras each produce a video input to the system, and the microphone produces an audio input to the system. A time counter provides a timeline associated with the multiple video inputs and the audio input. The timeline enables video input from each camera to be time-synchronized with the audio input from the microphone. Furthermore, the timeline produced by the time counter can be used to sync other input data, such as user interfaces, touchscreens, or smart board inputs, with the video and audio input. In some implementations, each camera can include a microphone, such as to produce an audio and video output. The audio and video output can be aligned as they are recorded at the same time. The video content from the various cameras can be aligned using the associated audio content, such as by aligning the audio content from the different audio video outputs, and thereby aligning the video content as well.

Multiple audiovisual clips are created by combining video inputs with a corresponding synchronized audio input. The system detects events in the audio input, video inputs, or both the audio and video inputs, such as a pause in speaking corresponding to low-audio input. The events correspond to a particular time in the synchronization timeline. To automatically assemble audiovisual files, the system concatenates a first audiovisual clip and a second audiovisual clip. The first audiovisual clip contains video input before the event, and the second audiovisual clip contains video input after the event. The system can further create audiovisual files that concatenate three or more audiovisual clips that switch between particular video inputs after predetermined events.

One example of an event that can be used as a marker for deciding when to cut between different video clips is a drop in the audio volume detected by the microphone. During recording, the speaker may stop speaking briefly, such as when switching between topics, or when pausing to collect their thoughts. These pauses can correspond to a significant drop in audio volume. In some examples, the system looks for these low-noise events in the audio track. Then, when assembling an audiovisual file of the video interview, the system can change between different cameras at the pauses. This allows the system to automatically produce high quality, entertaining, and visually interesting videos with no need for a human editor to edit the video interview. Because the quality of the viewing experience is improved, the viewer is likely to have a better impression of a candidate or other speaker in the video. A higher quality video better showcases the strengths of the speaker, providing benefits to the speaker as well as the viewer.

In another aspect, the system can remove unwanted portions of the video automatically based on the contents of the audio or video inputs, or both. For example, the system may discard portions of the video interview in which the individual is not speaking for an extended period of time. One way this can be done is by keeping track of the length of time that the audio volume is below a certain volume. If the audio volume is low for an extended period of time, such as a predetermined number of seconds, the system can note the time that the low noise segment begins and ends. In some examples, the predetermined number of seconds can be an adjustable or changeable value, such as a user or administrator can enter or select the desired number of predetermined seconds. A first audiovisual clip that ends at the beginning of the low noise segment can be concatenated with a second audiovisual clip that begins at the end of the low noise segment. The audio input and video inputs that occur between the beginning and end of the low noise segment can be discarded. In some examples, the system can cut multiple pauses from the video interview, and switch between camera angles multiple times. This eliminates dead air and improves the quality of the video interview for a viewer.

In another aspect, the system can choose which video input to use in the combined audiovisual file based on the content of the video input. For example, the video inputs from the multiple cameras can be analyzed to look for content data to determine whether a particular event of interest takes place. As just one example, the system can use facial recognition to determine which camera the individual is facing at a particular time. The system then can selectively prefer the video input from the camera that the individual is facing at that time in the video. As another example, the system can use gesture recognition to determine that the individual is using their hands when talking. The system can selectively prefer the video input that best captures the hand gestures. For example, if the candidate consistently pivots to the left while gesturing, a right camera profile shot might be subjectively better than minimizing the candidate's energy using the left camera feed. Content data such as facial recognition and gesture recognition can also be used to find events that the system can use to decide when to switch between different camera angles.

In another aspect, the system can choose which video input to use based on a change between segments of the interview, such as between different interview questions.

In some examples, the system can choose which video input to use based on quality of the video or quality of audio associated with a specific camera. For example, in some instances, each of the video cameras can have a microphone. The system can use the video input based on which camera's microphone has the highest quality audio. In some examples, the highest quality audio can be the loudest audio. In some examples, the highest quality audio can have the least amount of noise, such as the highest or best signal to noise ratio.

Scoring Candidate Empathy

The present disclosure further relates to a computer system and method for use in the employment field. The disclosed technology is used to select job candidates that meet desired specifications for a particular employment opening, based on quantitatively measured characteristics of the individual job candidate. In healthcare, an important component of a successful clinician is the capacity for empathy. The technology disclosed herein provides an objective measure of a candidate's empathy using video, audio, and/or behavioral data recorded during a video interview of the candidate. An empathy score model can be created, and the recorded data can be applied to the empathy score model to determine an empathy score for the job candidate. In another aspect, an attention to detail and a career engagement score can be determined for the candidate.

The system can also include a computer interface for presenting potential job candidates to prospective employers. From the user interface, the prospective employer can enter a request to view one or more candidates having qualities matching a particular job opening. In response to the request, the computer system can automatically select one or more candidates' video interviews, and send the one or more video interviews over a computer network to be displayed on a user computer.

The computer system can include a computer having a processor in a computer memory. The computer memory can store a database containing candidate digital profiles for multiple job candidates. The memory can also store computer instructions for performing the methods described in relation to the described technology. The candidate digital profiles can include candidate personal information such as name and address, career-related information such as resume information, one or more audiovisual files of a video interview conducted by the candidate, and one or more scores related to behavioral characteristics of the candidate. The information in the candidate digital profile can be used when the system is automatically selecting the candidate video interviews to be displayed on the user computer.

The method can be performed while an individual job candidate is being recorded with audio and video, such as in a video interview. In some examples, the video interview is recorded in a kiosk specially configured to perform the functions described in relation to the disclosed technology. Although the computer system and method will be described in the context of a video interview of an employment candidate, other uses are contemplated and are within the scope of the technology. For example, the system could be applied to recording individuals who are performing entertaining or informative speaking, giving lectures, medical consultation, or other settings in which an individual is being recorded with video and audio.

In one aspect of the technology, the system receives video, audio, and behavioral data recorded of a candidate while the candidate is speaking. In some examples, the system uses a kiosk with multiple video cameras to record video images, a microphone to record audio, and one or more sensors to detect behaviors of the candidate during the interview. As used herein, a sensor could be one of a number of different types of measuring devices or computer processes to extract data. One example of a sensor is the imaging sensor of the video camera. In this case, behavioral data could be extracted from the digital video images recorded by the imaging sensor. Another example of a sensor is an infrared sensor that captures motion, depth, or other physical information using electromagnetic waves in the infrared or near-infrared spectrum. Various types of behavioral data can be extracted from input received from an infrared sensor, such as facial expression detection, body movement, body posture, hand gestures, and many other physical attributes of an individual. A third example of a sensor is the microphone that records audio of a candidate's speech. Data extracted from the audio input can include the candidate's vocal tone, speech cadence, or the total time spent speaking. Additionally, the audio can be analyzed using speech to text technology, and the words chosen by the candidate while speaking can be analyzed for word choice, word frequency, etc. Other examples of sensors that detect physical behaviors are contemplated and are within the scope of the technology.

In one aspect of the technology, the system is used during a video interview of a job candidate. Particular predetermined interview questions are presented to the candidate, and the candidate answers the questions orally while being recorded using audio, video, and behavioral data sensors. In some examples, the nature of a particular question being asked of the candidate determines the type of behavioral data to be extracted while the candidate is answering that question. For example, at the beginning of the interview when the candidate is answering the first interview question, the system can use the measurements as a baseline to compare the candidate's answers at the beginning of the interview to the answers later in the interview. As another example, a particular interview question can be designed to stimulate an expected particular type of emotional response from the candidate, such as to elicit a response, such as when talking about his/her work with a hospice patient. Behavioral data recorded while the candidate is answering that interview question can be given more weight in determining an empathy for score for the candidate.

Some examples further include receiving information in addition to video, audio, and behavioral data. For example, written input such as resume text for the job candidate can be used as a factor in determining the suitability of a candidate for particular job opening. The system can also receive text or quantitative scores received from questionnaires filled out by the candidate, or filled out by another individual evaluating the candidate. This type of data can be used similarly to the behavioral data to infer characteristics about the candidate, such as the candidate's level of attention to detail, and/or the candidate's level of career engagement.

In another aspect, the disclosed technology provides a computer system and method for creating an empathy scoring model and applying the empathy scoring model to behavioral data of a candidate. In this method, the system receives data input for a population of candidates. The data input can include video, audio, and behavior data input recording during video interviews of each of candidates.

In some examples, the particular population of candidates is selected based on the candidates' suitability for a particular type of employment. For example, the candidates can be a group of healthcare professionals that are known to have a high degree of desirable qualities such as empathy. In alternative examples, the population of candidates can be selected from the general population; in this case, it would be expected that some candidates have a higher degree of desirable qualities, and some candidates have a lower degree of desirable qualities.

In either case, the system extracts behavioral data from the data inputs. A regression analysis is performed on the extracted behavioral data. This allows the system to identify particular variables that correspond to a degree of empathy of the candidate. The system then compiles a scoring model with weighted variables based on the correlation of empathy to the extracted quantitative behavioral data. The scoring model is stored in a candidate database. After the scoring model has been created, it can be applied to new data for job candidates.

The system applies the scoring model by receiving behavioral data input from the candidate and extracting behavioral data from the behavioral data input. The extracted behavioral data corresponds to variables found to be relevant to scoring the candidate's empathy. The extracted behavioral data is then compared to the model, and a score is calculated for the candidate. This score can be stored in the candidate's candidate digital profile along with a video interview for the candidate. This process is repeated for many potential employment candidates, and each candidate's score is stored in a digital profile and accessible by the system.

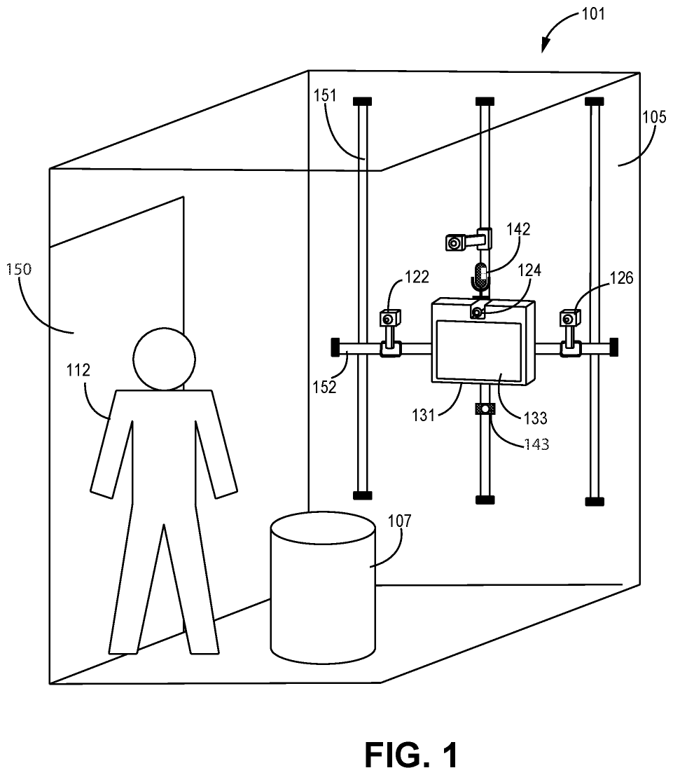

Video Interview Kiosk (FIG. 1)

FIG. 1 shows a kiosk 101 for recording a video interview of an individual 112. The kiosk 101 is generally shaped as an enclosed booth 105. The individual 112 can be positioned inside of the enclosed booth 105 while being recorded. Optionally, a seat 107 is provided for the individual 112. In some examples, the seat 107 can include a chair or a stool. In some examples, the height of the seating surface of the seat 107 is at least 17 inches and at most 20 inches, or about 18 inches. The kiosk 101 houses multiple cameras, including a first camera 122, a second camera 124, and a third camera 126. Each of the cameras is capable of recording video of the individual 112 from different angles. In the example of FIG. 1, the first camera 122 records the individual 112 from the left side, the second camera 124 records the individual 112 from the center, and the third camera 126 records the individual 112 from the right side. In some examples, the camera 124 can be integrated into a user interface 133 on a tablet computer 131. Instead of a tablet computer 131, a computer 131 can be used having the shape and size of a typical tablet computer. For example, computer 131 can be sized for easy movement and positioning by the user. In various embodiments, the computer 131 has a display screen size of at least about 5 inches, at least about 6 inches, at least about 7 inches, at most about 10 inches, at most about 12 inches, or a combination of these boundary conditions. In various embodiments, the computer 131 has a case depth of at least about 0.3 inch, at least about 0.4 inch, at most about 0.7 inch, at most about 1 inch, or a combination of these boundary conditions. The user interface 133 can prompt the individual to answer interview questions, show a video of the individual (such as a live video), or prompt the individual to demonstrate a skill or talent. A microphone 142 is provided for recording audio. In some examples, each camera 122, 124, 126 can include a microphone 142.

The first, second, and third cameras 122, 124, 126 can be digital video cameras that record video in the visible spectrum using, for example, a CCD or CMOS image sensor. Optionally, the cameras can be provided with infrared sensors or other sensors to detect depth, movement, etc. In some examples, one or more depth sensors 143 can be included in the kiosk 101.

In some examples, the various pieces of hardware can be mounted to the walls of the enclosed booth 105 on a vertical support 151 and a horizontal support 152. The vertical support 151 can be used to adjust the vertical height of the cameras and user interface, and the horizontal support 152 can be used to adjust the angle of the cameras 122, 124, 126. In some examples, the cameras can automatically adjust to the vertical position along vertical supports 151, such as to position the cameras at a height that is not higher than 2 inches (5 centimeters) above the candidate's eye height. In some examples, the cameras can be adjusted to a height of no more than 52 inches (132 centimeters) or no more than 55 inches (140 centimeters).

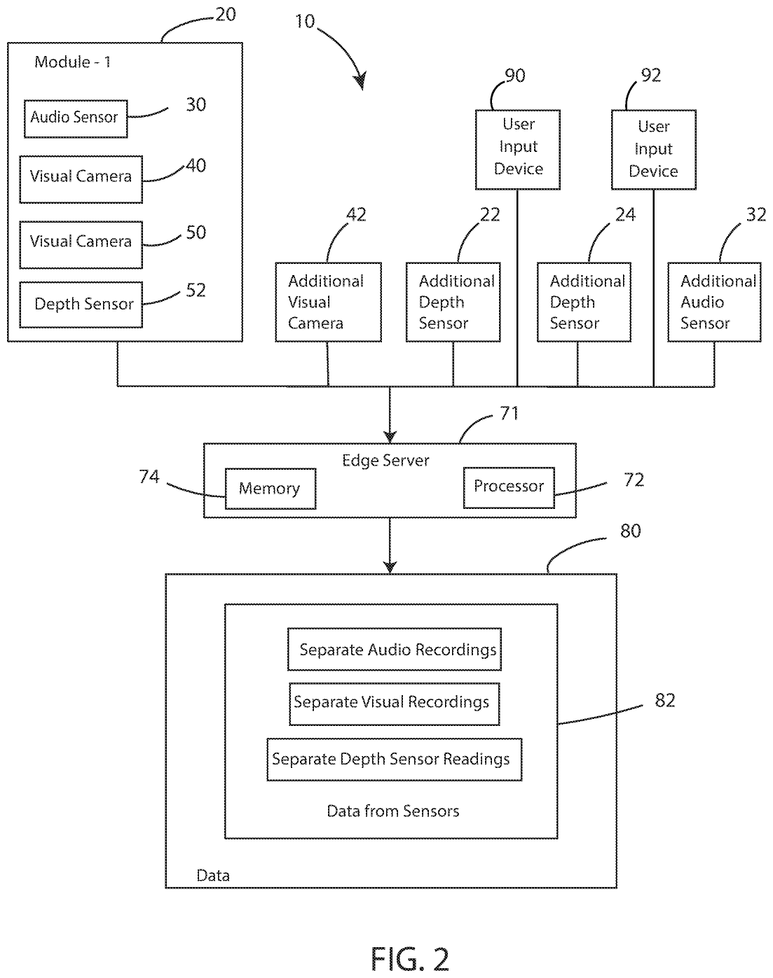

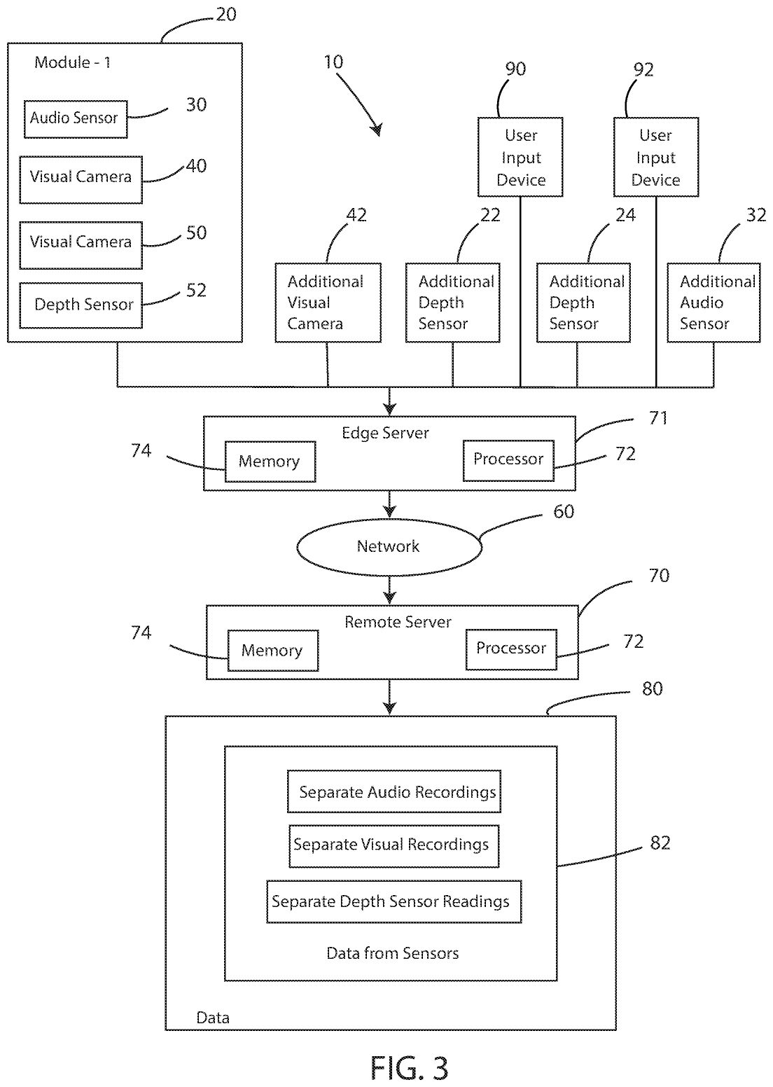

Overall System (FIGS. 2-3)

FIGS. 2 and 3 reveal the technical difficulties encountered and solved by the disclosed examples in the present application. A system 10 is designed to record and sense individuals in the kiosk, such as an individual participating in a recorded job interview. In one example, the system 10 uses sensor modules 20 that incorporate multiple different types of sensors. In FIGS. 2 and 3, Module-1 20 is shown with an audio sensor or microphone 30 to make sound recordings, at least two visual cameras 40, 50 to make visual recordings, and at least one behavioral or depth sensor 52 to record and more easily identify the physical movements of the individual.

The system 10 can also include one or more additional visual cameras 42 and one or more additional audio sensors 32. The additional visual cameras 42 and audio sensors 32 are designed to increase the coverage and quality of the recorded audio and visual data. In system 10, two additional depth sensors 22, 24 can also be present.

In some examples, such as shown in FIG. 3, the camera, modules, and sensors 20-52 can be in data communication with one or more remote servers 70 (which is generally referred to as a single server 70 in this description). This data communication can flow over a network 60, such as a wired or wireless local area network or even a wide area network such as the Internet.

In the examples shown in FIG. 3, the cameras, modules, and sensors 20-52 first communicate with an edge server 71, which in turn is responsible for communications with the remote servers 70 over the network 60. An edge server 71 provides local processing power and control over the cameras, modules, and sensors 20-52. In some circumstances, the edge server 71 can provide control interfaces to aim and adjust the settings of the cameras, modules, and sensors 20-52. In other circumstances, the edge server 71 can provide tracking capabilities for the cameras, modules, and sensors 20-52. For example, the visual cameras 40, 42 may include a motorized mount that allows for the identification and tracking of human faces with the edge server 71 providing the processing, programming, and power necessary to both identify and track those faces. In still further examples, the edge server 71 is responsible for taking input from the modules 20, 22, 24, 32, 42 and creating audiovisual output with a variety of camera angles.

While FIG. 3 is shown with the edge server 71 providing communications over the network 60 with the server 70, in other examples the jobs and capabilities of the remote server 70 are provided by the edge server 71 and no remote server 70 is needed, such as shown in FIG. 2. Also, capabilities that are described herein as being performed by the remote server 70 can, alternatively, or in addition, be performed by the edge server 71.

The server 70 and the edge server 71 are both computing devices that each include a processor 72 for processing computer programming instructions. In most cases, the processor 72 is a CPU, such as the CPU devices created by Intel Corporation (Santa Clara, Calif.), Advanced Micro Devices, Inc (Santa Clara, Calif.), or a RISC processer produced according to the designs of Arm Holdings PLC (Cambridge, England). Furthermore, the server 70 and edge server 71 have memory 74 which generally takes the form of both temporary random access memory (RAM) and more permanent storage such a magnetic disk storage, FLASH memory, or another non-transitory (also referred to as permanent) storage medium. The memory and storage component 74 (referred to as “memory” 74) contains both programming instructions and data. In practice, both programming and data will generally be stored permanently on non-transitory storage devices and transferred into RAM when needed for processing or analysis.

In FIGS. 2 and 3, data 80 is shown as existing outside of the server 70 or edge server 71. This data can be stored on the server 70, edge server 71, or could be stored elsewhere. This data 80 can be structured and stored as a traditional relational database, as an object-oriented database, or as a key-value data store. The data 80 can be directly accessed and managed by the server 70, or a separate database management computer system (not shown) can be relied upon to manage the data 80 on behalf of the server 70.

The separate camera recordings and sensed data from the sensors 22-52 are stored as sensor data 82. In one example, the data acquired from each camera, microphone and sensor 22-52 is stored as separate data 82.

In some embodiments, user input devices 90, 92 may also provide input into the server 70 or edge server 71. These user input devices may take a variety of forms such as keyboards or mice, but in the examples described herein they can also take the form of tablet computers, touchscreens, or smart whiteboard that are capable of receiving user input through touch. A user may be asked or prompted, for example, to respond to a question by selecting an answer presented on the tablet computer or touchscreen. Alternatively, the user may be asked to provide a written response to a prompt. In still further examples, a user may be asked to explain a concept or solve a problem by drawing on one of the input devices. Data received by these user input devices during the user's time in the kiosk can likewise be stored and organized along with the sensor data in data 80.

Possible Use of System 10

The system 10 can be used, for example in an interview setting where an individual is present and actively participating in an interview within a kiosk. In one example, an individual is seated in a kiosk. Multiple cameras 40, 42, 50 are positioned to record video images of the individual. Multiple behavioral sensors such as depth sensors 52, 22, 24 are positioned to record quantitative behavioral data of the individual. Multiple microphones 30, 32 are positioned to record the voices of the participant.

While the interview is conducted, an individual can be recorded with one or more sensors 20-52. For example, one or more cameras 40, 42, 50 can focus on the facial expression of the participant. In addition, or alternatively, one or more sensors 20-52 can focus on the body posture of the participant. One or more sensors 20-52 can focus on the hands and arms of the participant. The system 10 can evaluate the behavior of the participant in the interview. The system 10 can calculate a score for the participant in the interview. If the participant is a job candidate, then the system 10 can calculate a score for the candidate to assess their suitability for an open job position. The system 10 can assess the participant's strengths and weaknesses and provide feedback on ways the participant can improve performance in interviews or in a skill. The system 10 can observe and describe personality traits that can be measured by physical movements. In some examples, when a participant is talking, the system 10 can extract keywords from the participant's speech using a speech to text software module.

The system provides evaluation modules that use recorded data as input. In the various examples herein, “recorded data” refers only to data that was recorded during the interview, such as data 82. Recorded data can be recorded audio data, recorded video data, recorded input device data, and/or recorded behavioral sensor data. Recorded data can mean the raw data received from a sensor 20-52 and input devices 90, 92, or it can be data converted into a file format that can be stored on a memory and later retrieved for analysis.

The evaluation modules also use extracted data as input. As used herein, “extracted data” is information that is extracted from raw data of the recorded audio, recorded video, or recorded behavioral sensor data. For example, extracted data can include keywords extracted from the recorded audio using speech to text software. Extracted data can also include body posture data extracted from the behavioral sensor data, or eye-movement data extracted from the recorded video. Other examples are possible and are within the scope of the technology.

The evaluation modules can also use external data as input. “External data,” as used herein, is data other than that recorded during the interview. External data can refer to audio data, video data, and/or behavioral sensor data that was recorded at some time other than during the interview. External data also can refer to text data imported from sources external to the interview. In the context of an interview, for example, the external data may include resumes, job descriptions, aptitude tests, government documents, company mission statements, and job advertisements. Other forms of external data are possible and are within the scope of the technology.

The system 10 is capable of storing data in a database structure. As used herein, “stored data” refers to data that is stored in at least one database structure in a non-volatile computer storage memory 74 such as a hard disk drive (HDD) or a solid-state drive (SSD). Recorded data, extracted data, and external data can each be stored data when converted into a format suitable for storage in a non-volatile memory 74.

In some examples, the system 10 can be further configured to capture video input of the user from a first camera, capture video input of the user from a second camera, capture behavioral data input from a depth sensor, and capture audio input of the user from a microphone. Once the system 10 has captured at least some data, the system 10 can align the video from the first camera, the video from the second camera, the input data, the behavioral data, and the audio input with a time counter. This alignment allows for a synchronization of all of this data so that data received from the same time segment from one input or sensor can be compared to date received at the same time from a different input or sensor. The system 10 can then extract behavioral data from the behavioral data input and associate a prompted question or demonstration of skill with the extracted behavioral data.

In some examples, the system 10 can be configured to associate a prompted question or demonstration of a skill with extracted behavioral data. The system can then process the audio data with speech to text analysis and compare subject matter in the audio data to a behavioral characteristic. In some examples, the behavioral characteristic is selected from the group consisting of sincerity, empathy, and comfort.

In some examples, the system 10 can further automatically concatenate a portion of the first captured video data and a portion of the second captured video data. The system 10 can further automatically save the concatenated video data with the audio data as a single audiovisual file.

In some examples, the system 10 can include multiple microphones. They system can use the audio input from a selected microphone for the single audiovisual file. In some examples, the audio input is selected from the microphone that has the highest volume. In some examples, the audio input is selected from the microphone that has the lowest noise to signal ratio. In some examples, each camera can have an associated microphone. The system 10 can select video from a camera that is associated with the microphone which captured the audio being used. For example, while audio from microphone #1 is being used, video from camera #1 is being used, and when audio from microphone #2 is being used, video from camera #2 is being used. This can also work in reverse, with cameras being selected based on an analysis of the user and the microphone associated with the selected camera being used for audio.

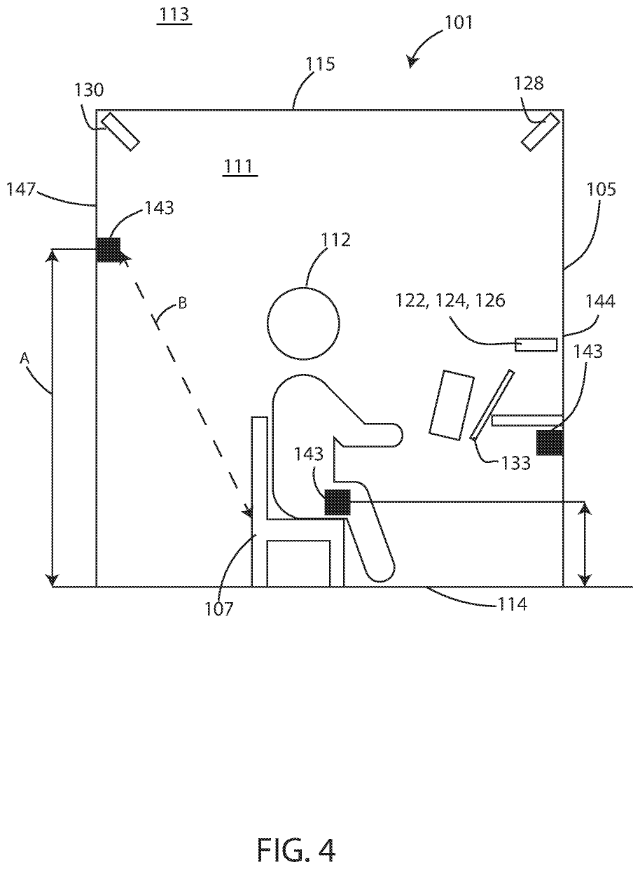

Kiosk Layout (FIGS. 4-7)

FIG. 4 shows a schematic side view of a cross-section of the kiosk 101 according to some examples. The kiosk 101 can include a booth 105. The booth 105 can include an enclosing wall 110. The enclosing wall 110 can form a perimeter of the booth 105. The enclosing wall 110 can define an interior 111 of the booth 105 and an exterior 113 of the booth 105.

In various examples, the perimeter defined by the enclosing wall 110 can be at least 14 feet (4.3 meters) and not more than 80 feet (24.4 meters). In some examples, the perimeter defined by the enclosing wall 110 can be at least 10 feet (3.0 meters), at least 12 feet (3.7 meters), at least 14 feet (4.3 meters), at least 16 feet (4.9 meters), at least 18 feet (5.5 meters), or at least 20 feet (6.1 meters). In some examples, the perimeter defined by the enclosing wall 110 can be no more than 100 feet (30.5 meters), no more than 90 feet (27.4 meters), no more than 80 feet (24.4 meters), no more than 70 feet (21.3 meters), no more than 60 feet (18.3 meters), no more than 50 feet (15.2 meters), no more than 40 feet (12.2 meters), or no more than 30 feet (9.1 meters). It should be understood that the perimeter can be bound by any combination of the lengths listed above.

In various examples, the wall 110 can extend from a bottom 114 of the booth 105 to a top 115 of the booth 105. In various examples, the enclosing wall 110 can have height (from bottom 114 to top 115) of at least 5 feet (1.5 meters) and not more than 20 feet (6.1 meters). In various examples, the enclosing wall 110 can have height of at least 6 feet (1.8 meters) and not more than 15 feet (4.6 meters). In various examples, the enclosing wall 110 can have height of at least 7 feet (2.1 meters) and not more than 13 feet (4.0 meters). In various examples, the enclosing wall can include a frame and panels. In some examples, the frame can include extruded metal, such as extruded aluminum. In some examples, the panels can include a polymer, such as polycarbonate, acrylic, or polymethyl methacrylate. In some examples, the panels can be opaque, translucent, or semi-translucent.

In various examples, the side walls 145, 146 can extend over a length between the front wall 144 and the back wall 147. For side wall 145, the side wall length includes the extent of a door 150. The side wall length can be at least 5 feet (1.5 meters) and not more than 20 feet (6.1 meters), at least 6 feet (1.8 meters) and not more than 15 feet (4.6 meters), at least 7 feet (2.1 meters) and not more than 13 feet (4.0 meters), about 7 feet, about 8 feet, or have a boundary of any of these values.

In various examples, the front and back walls 144, 147 can extend over a length between the two side walls 145, 146. The front and back wall length can be at least 3 feet (meters) and not more than 20 feet (6.1 meters), at least 4 feet (meters) and not more than 15 feet (meters), at least 5 feet (2.1 meters) and not more than 8 feet (meters), about 4 feet, about 5 feet, or have a boundary of any of these values.

In some examples, the booth 105 can include a roof. In some examples, the roof can comprise the same type of panels as the enclosing wall 110. In some examples, the roof can include solar panels. In some examples, the booth 105 does not include a roof, such as a roof that connects to the enclosing wall 110. In some examples, the booth 105 can be intended for indoor applications, and such a roof may not be included. In some examples, a noise canceling machine or a white noise machine can be disposed within the booth 105, such as when the booth does not have a roof and is located in a noisy environment.

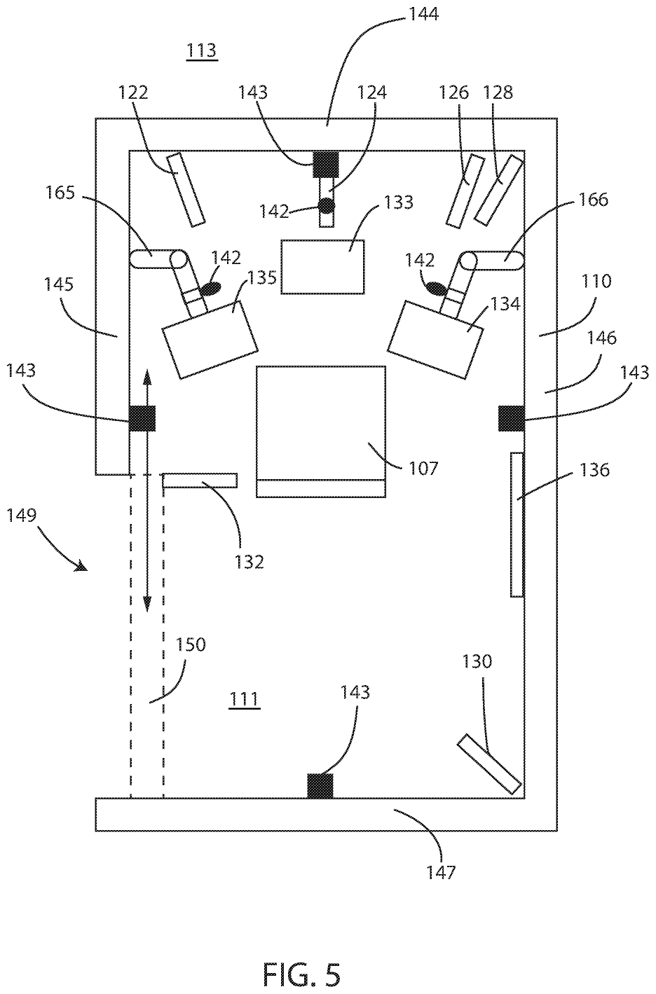

As shown in FIG. 5, the enclosing wall 110 can include a front wall 144, a back wall 147, a first side wall 145, and a second side wall 146. The front wall 144 can be opposite from the back wall 147. The front wall 144 can be parallel with the back wall 147. In some examples, the front wall 144 can be substantially parallel with the back wall 147, such as within 5° of parallel. In some examples, the front wall 144 can be substantially parallel with the back wall 147, such as when one or both of the walls 144, 147 are not planar.

The first side wall 145 can be opposite from the second side wall 146. The first side wall 145 can be parallel to the second side wall 146. In some examples, the first side wall 145 can be substantially parallel with the second side wall 146, such as within 5° of parallel. In some examples, the first side wall 145 can be substantially parallel with the second side wall 146, such as when one or both of the walls 145, 146 are not planar.

The first side wall 145 can extend from the front wall 144 to the back wall 147. The second side wall 146 can extend from the front wall 144 to the back wall 147. The first side wall 145 can be perpendicular to the front wall 144 and the back wall 147. The second side wall 146 can be perpendicular to the front wall 144 and the back wall 147.

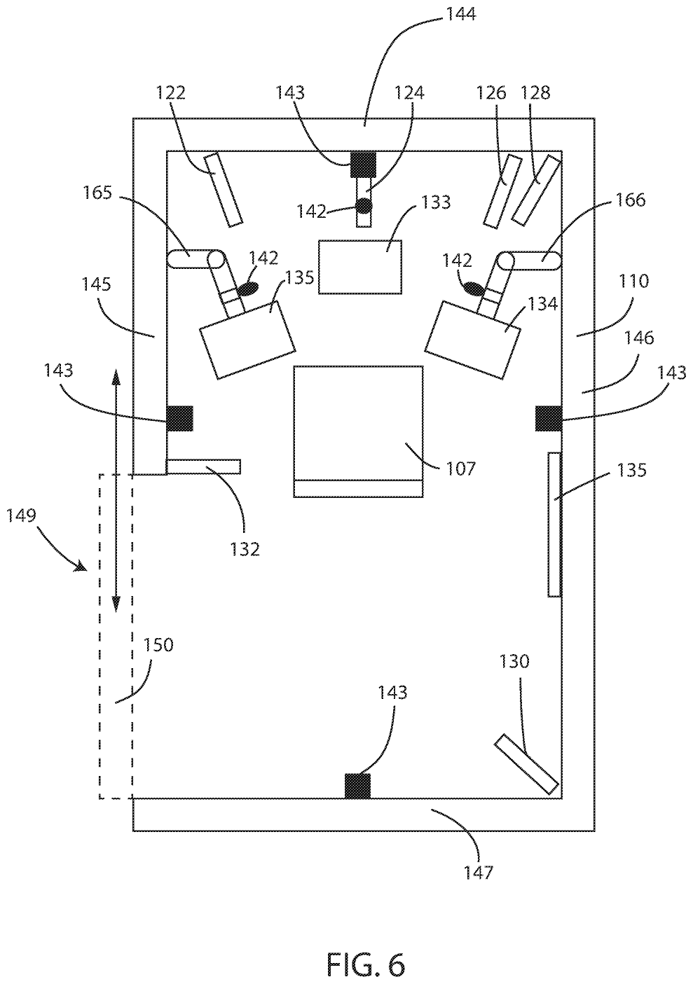

In some examples, the first side wall 145 or the second side wall 146 can define a door opening 149. In some examples, the minimum clearance for the door opening 149 is 42 inches (107 centimeters) or 40 inches (102 centimeters). In some examples, the first side wall 145 or the second side wall 146 can include a door 150, such as a sliding door 150 or a barndoor type door with overhead rollers. In some examples, the door 150 can include the same materials as the enclosing wall 110. In some examples, the door 150 can be disposed within the interior 111, such as shown in FIG. 5. In other examples, the door 150 can be disposed on the exterior of the booth 105, such as shown in FIG. 6.

Cameras

In various examples, the booth 105 can include a first camera 122, a second camera 124, and a third camera 126. FIG. 5 shows a schematic top view of a booth 105. In some examples, the first camera 122, the second camera 124, and the third camera 126 are aimed proximally toward the booth interior. In some examples, the first camera 122, the second camera 124, and the third camera 126 are disposed adjacent to the front wall 144, such as being within on the same half or same quarter of the booth as the front wall 144. Being within the same half or the same quarter of the booth can mean being within a portion of the booth that extends from the first side wall 145 to the second side wall 146 and has a depth (in the direction of the front wall 144 to the back wall 147) of half or a quarter of the total length from the front wall 144 to the back wall 147. In some examples, each of the first camera 122, the second camera 124, and the third camera 126 are mounted to the front wall 144. In some examples, one camera can be mounted to the first side wall 145, one camera can be mounted to the front wall 144, and one camera can be mounted to the second side wall 146.

In some examples, the cameras 122, 124, 126 can be disposed within the walls. In one example, the first camera 122, the second camera 124 and the third camera 126 can all be disposed within the front wall 144. In one example, the first camera 122 is disposed within the first side wall 145, the second camera 124 is disposed within the front wall 144, and the third camera 126 is disposed within the second side wall 146.

In some examples, the first camera 122, the second camera 124, and the third camera 126 can be disposed at a height of at least 30 inches (762 centimeters) and not more than 70 inches (178 centimeters) from the bottom 114. In some examples, the cameras 122, 124, 126 can be disposed at a height of at least 30 inches (762 centimeters), at least 35 inches (889 centimeters), at least 40 inches (102 centimeters), at least 45 inches (114 centimeters) or at least 50 inches (127 centimeters). In some examples, the cameras 122, 124, 126 can be disposed at a height of no more than 80 inches (203 centimeters), no more than 75 inches (190 centimeters), no more than 70 inches (178 centimeters), no more than 65 inches (165 centimeters), no more than 60 inches (152 centimeters), or no more than 55 inches (140 centimeters). It should be understood that the cameras 122, 124, 126 can be disposed a height bound by any combination of the heights listed above.

In one example, the cameras 122, 124, 126 are positioned so as to be approximately level with the eye height of a sitting individual. When sitting on an average height chair, an average woman would have an eye height of about 45 inches. When sitting on an average height stool (which is generally taller than a chair), an average man would have an eye height of about 52 inches. If a three-inch variation for sitting eye height from average provides for reasonably expected variations from these average, all three cameras would be at an eye height between 42 and 53 inches. Positioning the cameras at a height that is appropriate for most users increases the changes of the user looking at one of the cameras during a video interview, leading to a higher-quality video interview that portrays the user as making eye contact with the viewer. By providing the perception of eye contact with the user and a viewer of the video resume, the system increases the chances of the user being perceived as engaging, confident, and likeable.

In some examples, the booth 105 can include a fourth video camera 128 and/or a fifth video camera 130. In some examples, the fourth camera 128 can be disposed adjacent to or in the corner of a front wall and a side wall (such as a side wall that is opposite from a door). In some examples, the fifth camera 130 can be disposed adjacent to or in the corner of a back wall and a side wall (such as a side wall that is opposite from a door). The fourth camera 128 and/or fifth camera 130 can be aimed to focused towards the door of the booth 105.

In some examples, the fourth camera 128 and/or the fifth camera 130 can include an infrared camera. In some examples the fourth camera 128 and/or the fifth camera 130 can be configured as an occupancy sensor, such as to monitor the number of people within the booth 105. In some implementations, the system can provide a security warning if one or more people are determined to be within the booth 105 when the system does not expect any people to be within the booth 105. In some implementations, the system can provide a cheating warning if two or more people are determined to be within the booth 105 when the system only expects one person to be in the booth 105.

In some examples, the fourth and/or fifth cameras 128, 130 can be disposed near the top 115 of the booth 105. In some examples, the fourth and/or fifth cameras 128, 130 can be disposed at a height of at least 50 inches (127 centimeters) from the bottom of the enclosing wall. In some examples, the fourth and/or fifth cameras 128, 130 can be disposed at a height of at least 60 inches (152 centimeters) from the bottom of the enclosing wall. In some examples, the fourth and/or fifth cameras 128, 130 can be disposed at a height of at least 65 inches (165 centimeters) from the bottom of the enclosing wall. In some examples, the fourth and/or fifth cameras 128, 130 can be disposed at a height of at least 70 inches (178 centimeters) from the bottom of the enclosing wall. In some examples, the fourth and/or fifth cameras 128, 130 can be disposed at a height of at least 72 inches (183 centimeters) from the bottom of the enclosing wall. In some examples, the fourth and/or fifth cameras 128, 130 can be disposed at a height of at least 75 inches (191 centimeters) from the bottom of the enclosing wall. In some examples, the fourth and/or fifth cameras 128, 130 can be disposed at a height of at least 80 inches (203 centimeters) from the bottom of the enclosing wall. In some examples, the fourth and/or fifth cameras 128, 130 can be disposed at a height of at least 85 inches (216 centimeters) from the bottom of the enclosing wall. In some examples, the fourth and/or fifth cameras 128, 130 can be disposed at a height of at least 90 inches (229 centimeters) from the bottom of the enclosing wall. In some examples, the fourth and/or fifth cameras 128, 130 can be disposed at a height of at least 95 inches (241 centimeters) from the bottom of the enclosing wall. In some examples, the fourth and/or fifth cameras 128, 130 can be disposed at a height of at least 100 inches (254 centimeters) from the bottom of the enclosing wall.

In some examples, the cameras 122, 124, 126, 128, 130, 132 can include digital video cameras, such as high definition video cameras. In some examples, the cameras can include wide angle cameras.

Microphones

The booth 105 can include one or more microphones 142 for receiving sound. In various examples, the one or more microphones 142 can be disposed within the booth interior 111. In some examples, the booth can include one microphone 142. In some examples, the booth can associate one microphone for each of the cameras 122, 124, 126 disposed within the booth interior 111. In some examples, the microphones 142 can be mounted adjacent their associated cameras 122, 124, 126. In other examples, the microphones 142 are incorporated within the housing for each cameras 122, 124, 126.

Depth Sensor

In various examples, the booth 105 can include one or more depth sensors 143 for capturing behavioral data. In some examples, a depth sensor can be disposed on a side wall of the booth 105. In some examples, a depth sensor can be disposed on a back wall of the booth. In some examples, a depth sensor 143 can be disposed on a front wall of the booth.

The depth sensor 143 can be disposed at a height of at least 20 inches (51 centimeters) and not more than 45 inches (114 centimeters). In some examples, the depth sensor 143 can be disposed at a height of at least 15 inches (38 centimeters), at least 20 inches (501 centimeters), at least 25 inches (64 centimeters), at least 30 inches (76 centimeters), at least 35 inches (89 centimeters), or at least 40 inches (102 centimeters). In some examples, the depth sensor 143 can be disposed at a height of no more than 55 inches (140 centimeters), no more than 50 inches (127 centimeters), no more than 45 inches (114 centimeters), no more than 40 inches (102 centimeters), no more than 35 inches (89 centimeters), or no more than 30 inches (76 centimeters). It should be understood that the depth sensor 143 disposed on a side wall, a back wall, or a front wall can be disposed a height bound by any combination of the heights listed above.

In various examples, one or more of the depth sensors can have a detection range where the depth sensor is able to detect changes in position of the individual. In some examples, at least one depth sensor can be configured to have its detection range to include the candidate's hands, face, body, torso, right shoulder, left shoulder, left waist, right waist, legs, or feet. In some examples, at least one depth sensor is configured to detect foot movement, torso movement, body posture, body position, facial expressions, or hand gestures.

In some examples, one or more of the depth sensors can have a detection range that includes the ground, floor, or bottom of the booth and extends upwards no more than 12 inches (30 centimeters), no more than 16 inches (41 centimeters), no more than 20 inches (51 centimeters), no more than 24 inches (61 centimeters), no more than 28 inches (71 centimeters), or no more than 32 inches (81 centimeters). In some examples, one or more depth sensors can have a detection range of at least 20 inches (51 centimeters) off the ground to no more than 38 inches (97 centimeters). In some examples, one or depth sensors can have a detection range of at least 24 inches (61 centimeters) and not more than 36 inches (91 centimeters).

In some examples, a depth sensor that is disposed on a back wall can be mounted higher than a depth sensor that is disposed on a side wall. In some examples, a depth sensor on a side wall or back wall can be mounted at a height that is less than the height at which camera 122, 124, 126 is mounted at. A depth sensor 143 mounted on the back wall 147 (a back wall depth sensor), can be located above a minimum height, at a minimum distance from the candidate's seat 107, or both, in order to improve the ability of the sensor to sense and record torso movement of a user. These minimum distances allow for the back depth sensor to have a sufficient angle of sensing in order to allow for gathering user movement data despite side-to-side, front-to-back, and/or height variation in the position of the user and the user's torso. Such variation can be introduced because of the varying body sizes and heights of the users, if the chair or stool is moved within the booth, and during the user's body movement over the course of recording a video interview. The minimum distances provide a physical infrastructure that allows robust gathering of user movement data in this variable environment. In particular, it is valuable to reliably gather robust and detailed movement data about a user's torso including shoulders using the back wall depth sensor. Referring now to FIG. 4, in various examples, a back wall depth sensor is located at a height off the booth floor of distance A and is spaced from the back of the seat 107 at the seating surface by a distance B. Assuming that the seating surface of the seat 107 is at a height of about 18 inches, distance A can be at least 12 inches (30 centimeters), at least 18 inches (45 centimeters), at least 24 inches (60 centimeters), at least 30 inches (76 centimeters), at least 36 inches (91 centimeters), at least 42 inches (106 centimeters), at least 48 inches, at least 54 inches, at least 60 inches, at least 66 inches, or at least 72 inches away.

Distance B can be at least 12 inches (30 centimeters), at least 18 inches (45 centimeters), at least 24 inches (60 centimeters), at least 30 inches (76 centimeters), at least 36 inches (91 centimeters), at least 42 inches (106 centimeters), at least 48 inches, at least 54 inches, at least 60 inches, at least 66 inches, or at least 72 inches away. In some examples, the seat 107 can be disposed approximately halfway between the front wall 144 and the back wall 147.

In various examples, the back wall depth sensor can be aimed at the likely location of the user's shoulder. The back wall depth sensor can be aimed downward at the user, if the depth sensor is mounted at a location higher than the likely location of the user's shoulders.

In various examples, the depth sensor can be aimed proximally toward the booth interior. In some examples, the depth sensor can include a stereoscopic optical depth sensor, an infrared sensor, a laser sensor, or a LIDAR sensor. In some examples, the booth 105 can include a combination of different types of depth sensors. In some examples, the booth 105 can include multiple depth sensors of the same type.

User Interfaces

The booth 105 can include one or more user interfaces. In some examples, the booth 105 includes a primary or centered user interface and one or more additional user interfaces. In one example, the booth 105 can include a primary user interface 133 that is substantially centered relative to a chair or stool within the booth 105. The primary user interface 133 can display a video of the candidate, such as a live video feed. In some examples, the user interface 133 can prompt the candidate to demonstrate a skill or talent or prompt the candidate to answer one or more questions. In other examples, a second user interface 134 can prompt the candidate and the first user interface 133 can display a video of the candidate or the interior of the booth 105. In some examples, a third user interface 135 can be included in the booth. In some examples, the candidate can use the third user interface 135 to demonstrate the skill or talent, such as by entering information into the third user interface 135. In other examples, the third user interface 135 can prompt the candidate and the candidate can use the second user interface 134 to demonstrate the skill of talent, such as by entering information into the second user interface 134.

In some examples, a fourth user interface 136 can be included in the booth. In some examples, the candidate can use the fourth user interface 136 to demonstrate the skill or talent, such as being entering information into the fourth user interface 136.

In some examples, the fourth user interface 136 provides a simple, non-electronic item such as a whiteboard, a flip pad, wipe-off board, or other product that the candidate can write on. In such examples, an additional video camera 132 can be provided opposite to the fourth user interface 136 for the system to capture the information provided by the candidate, such as shown in FIG. 5.

The electronic user interfaces 133, 134, 135, 136 can be a device that a candidate can use during the interview such as a desktop personal computer (PC), a tablet or laptop PC, a netbook, a mobile phone or other handheld device, a kiosk, or another type of communications-capable, such as an interactive whiteboard (IWB) also commonly known as Interactive board or Smart board. An IWB is a large interactive display in the form factor of a whiteboard such as available from SMART Technologies, Calgary, Alberta, Canada. These interactive whiteboards can either be a standalone touchscreen computer used independently to perform tasks and operations, or a connectable apparatus used as a touchpad to control computers from a projector.

In some examples, one or more of the user interfaces 133, 134, 135, 136 can be mounted on an adjustable arm. In some examples, the arms can be adjustable, such as to rotate or translate from a first position to a second position. In the first position, the arm and/or user interface can be located adjacent to a wall, and in the second position the user interface can be located adjacent to or near the candidate, such as when the candidate is in the seat 107. In some examples, the user interfaces 133, 134, 135, 136 can be mount to an adjustable arm via a rotatable coupling, such that the user interface 133, 134, 135, 136 can rotate relative to the adjustable arm, such as to transition from a landscape orientation to a portrait orientation.

As shown in FIG. 5, in an example, the third user interface 135 can be mounted on an arm 165, and the second user interface 134 can be mounted on a second arm 166. In some examples, the arm 165 can be mounted to or coupled to the first side wall 145, and the second arm 166 can be mounted to or coupled to the second side wall 146. In other examples, the arms 165, 166 can be mounted to or coupled to the front wall 144 or to a free-standing element that contacts the ground or floor.

Edge Server Locations

In various examples, the booth 105 can include an edge server. The edge server can be connected to the cameras, the depth sensors, the microphones, and the user interfaces. In some examples, the edge server can be located in the seat 107. In some examples, the edge server can be located outside of the booth interior 111, such as adjacent to the exterior of the enclosing wall. One example of such an exterior location is mounted on the exterior surface of front wall 144. In some examples, the edge server can be located on or within the roof, when there is a roof.

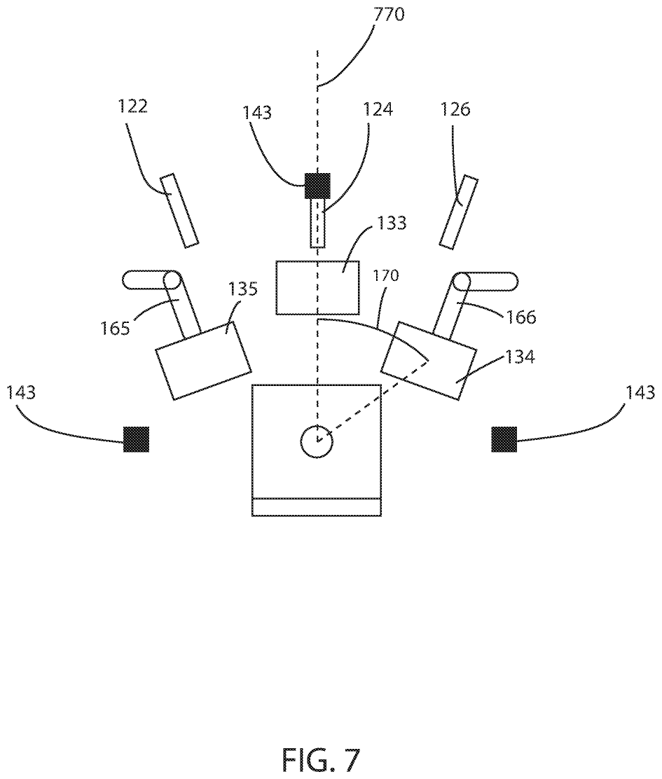

Positions of Components (FIG. 7)

FIG. 7 is a schematic top view of a kiosk according to some examples. A center line 770 is shown in FIG. 7. In some examples, the center line 770 represents a center line of the seat 107. The center line 770 is defined as the line between the center point of the seat 107 and the central or second camera 124, for embodiments having a central camera 124 present in the kiosk. For embodiments where there is no central camera 124, the center line 770 is a center line between the first side wall 145 and the second side wall 146. The angle 170 can represent an angle between the center line 770 and the center of a component, such as a camera or user interface. In the discussion below, the angle 170 is defined in a clockwise arc from the center line 770.

In an example, three cameras can be disposed in front of the seat 107, such as one at angle 170 of 330°, one at an angle 170 of 0°, and one at an angle 170 of 30°. In an example, one camera can be positioned at an angle 170 of at least 15° and not more than 45°, and a second camera can be positioned at an angle 170 of at least 315° and not more than 345°. In some examples, a third camera can be positioned at an angle of between 345° and 15°, such as between 345° and 360°, or between 0° and 15°.

In an example, one camera can be positioned at an angle 170 of at least 240° and not more than 300°, and a second camera can be positioned at an angle 170 of at least 60° and not more than 120°. In some examples, a third camera can be positioned at an angle of between 345° and 15°.

In an example, three user interfaces can be disposed in front of the seat 107, such as one at angle 170 of 330°, one at an angle 170 of 0°, and one at an angle 170 of 30°. In an example, one user interface can be positioned at an angle 170 of at least 15° and not more than 45°, and a second user interface can be positioned at an angle 170 of at least 315° and not more than 345°. In some examples, a third user interface can be positioned at an angle of between 345° and 15°,

In an example, one depth sensor can be positioned at an angle 170 of at least 240° and not more than 300°, and a second depth sensor can be positioned at an angle 170 of at least 60° and not more than 120°. In some examples, a third depth sensor can be positioned at an angle of between 345° and 15°. In other examples, a third depth sensor can be positioned at an angle of between 165° and 195°.

In one example, one depth sensor is located at 0°, one depth sensor is located at 90°, and one depth sensor is at 270°. In one example, one depth sensor is located at 180°, one depth sensor is located at 90°, and one depth sensor is at 270°. In one example, one depth sensor is located at 0°, one depth sensor is located at 180°, one depth sensor is located at 90°, and one depth sensor is at 270°.

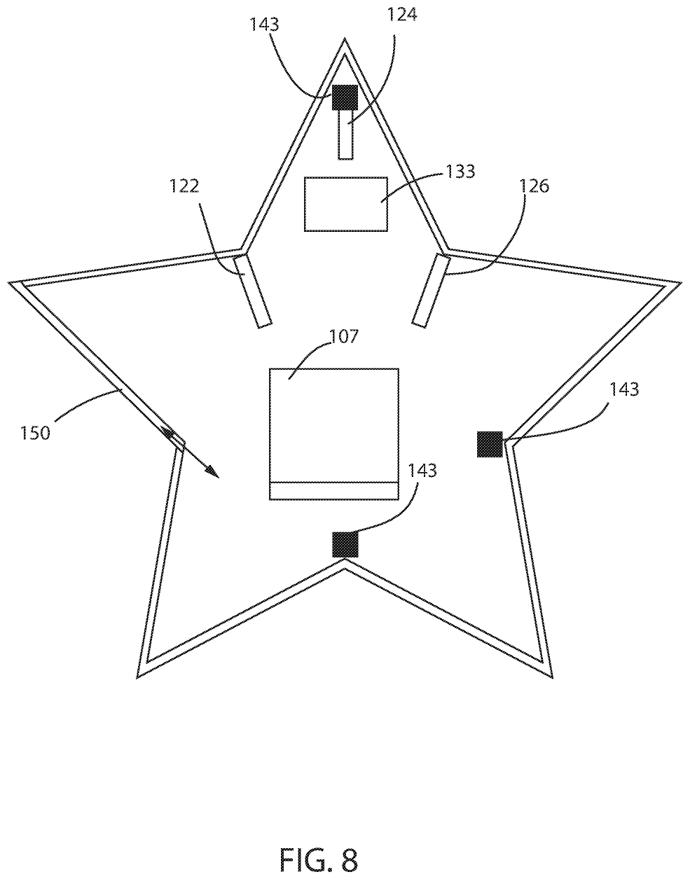

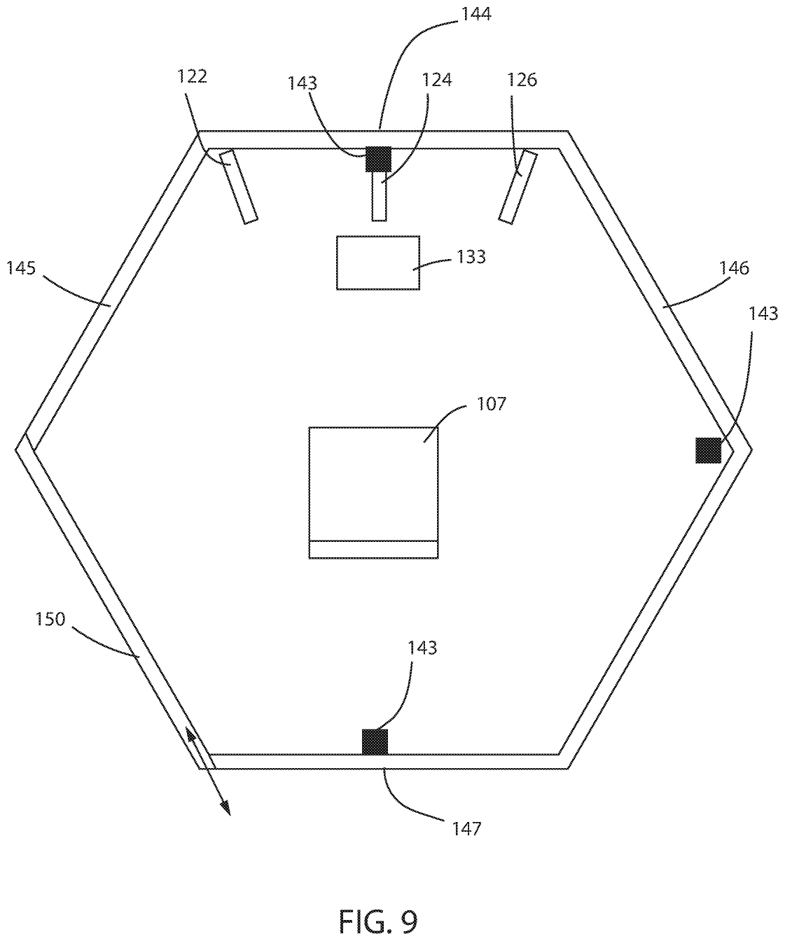

Additional Kiosk Shapes (FIGS. 8-9)

In some implementations, the enclosing wall can be configured in different shapes. For example, in some implementations the enclosing wall can define a rectangle, as shown in FIGS. 5-6. In some implementations, the enclosing wall can define a star-shape, as shown in FIG. 8. In some implementations the enclosing wall can define a shape with exactly one, two, three, four, five, or six lines of symmetry. In some implementations, the enclosing wall can define a polygon or a regular polygon, such as a pentagon shown in FIG. 9. In other implementations, the enclosing wall can define a circle, a square, a rectangle, a triangle, a pentagon, a hexagon, a heptagon, an octagon, or nonagon.

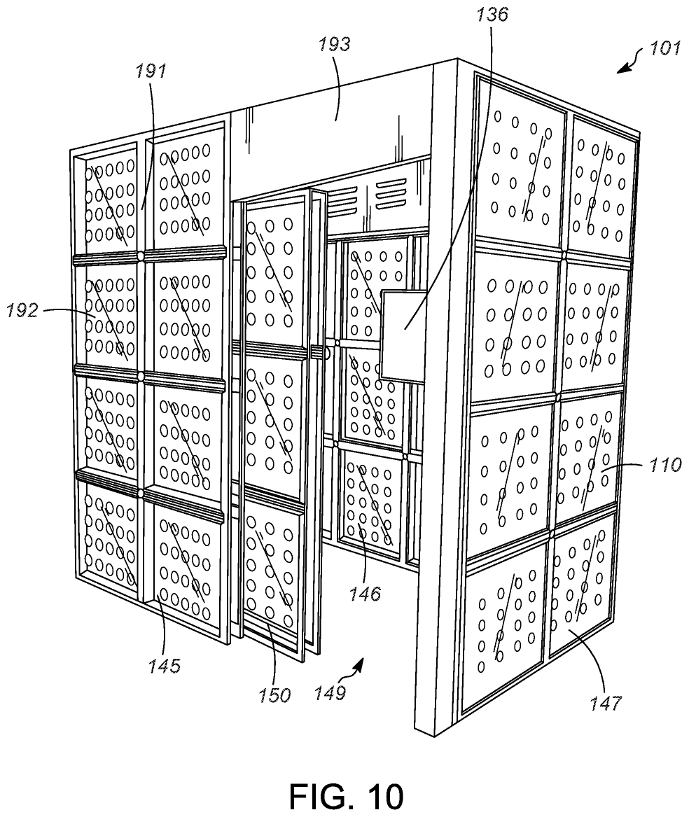

Kiosk Example (FIGS. 10-15)

FIGS. 10-15 show an example of a kiosk 101. The kiosk 101 shown in FIGS. 10-15 at least includes a first camera 122, a second camera 124, a third camera 126, a fourth camera 128, and an additional camera 132.

FIG. 10 shows a perspective view of a kiosk 101 in accordance with an example. The enclosing wall 110 can include a frame 191 and a plurality of panels 192. In some examples, the enclosing wall 110 can define a rectangular perimeter. The enclosing wall 110 can define a door opening 149. The enclosing wall 110 can include a door 150. The door 150 in FIG. 10 is shown in a partially open, partially closed state.

In some examples, portions of the enclosing wall 110 can include a changeable surface 193, such as a video board, a LCD display, or a LED board. The changeable surface 193 can be configured to display information which can be changed, such as electronically changed. In some examples, portions of the enclosing wall 110 can include vent or apertures for ventilation of the booth interior.

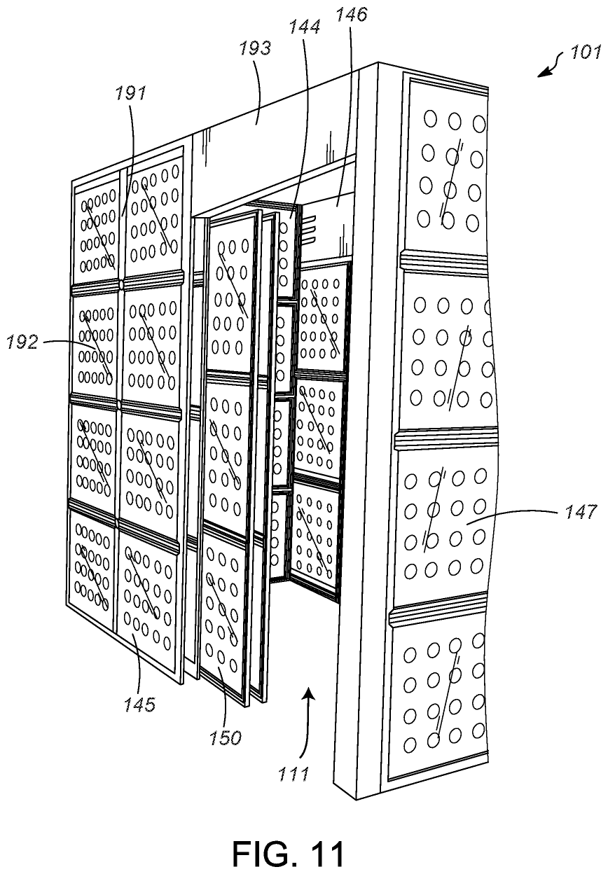

FIG. 11 shows an alternative perspective view of the kiosk 101 with the door 150 in a partially open, partially closed state, such that different portions of the booth interior 111 are shown. FIG. 11 shows an interior surface of the front wall 144 and an interior surface of the second side wall 146.

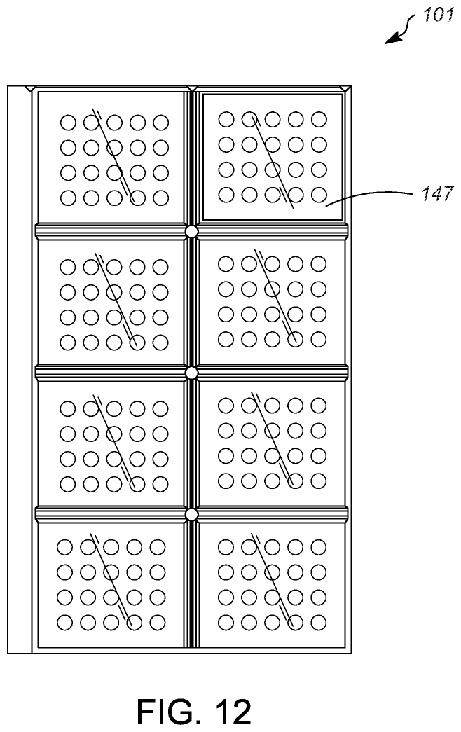

FIG. 12 shows an end view of the kiosk 101 shown in FIGS. 10-11. In some examples, the back wall 147 can be rectangular. In various examples, the door 150 and/or the first side wall 145 can be visible from the exterior back end of the kiosk 101.

FIG. 13 shows a portion of the booth interior 111. Specifically, FIG. 13 shows the corner of the front wall 144 and the second side wall 146. FIG. 13 further shows a centered camera 124 and an offset camera 126. FIG. 13 also shows an additional camera 128 mounted near the top of the kiosk 101.

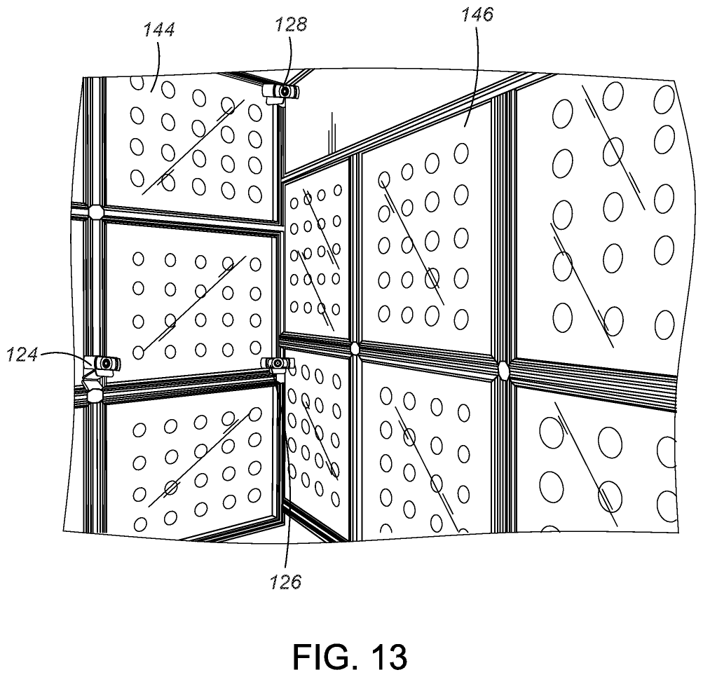

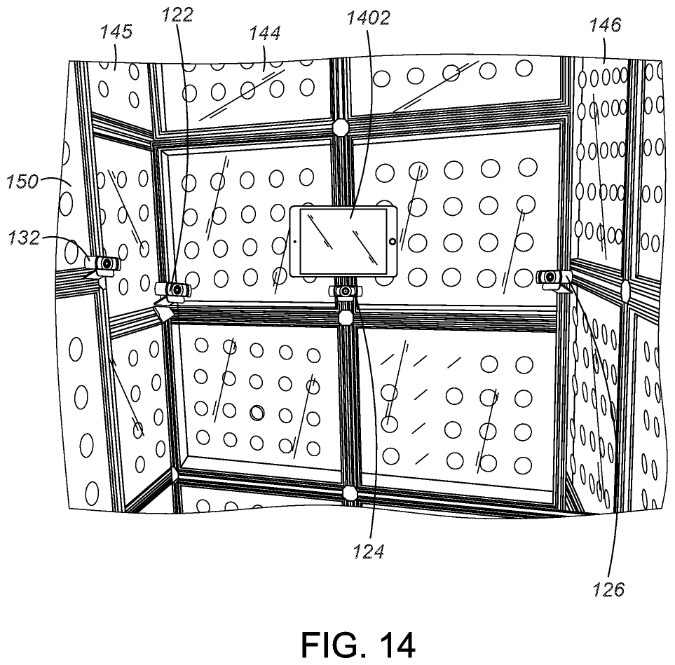

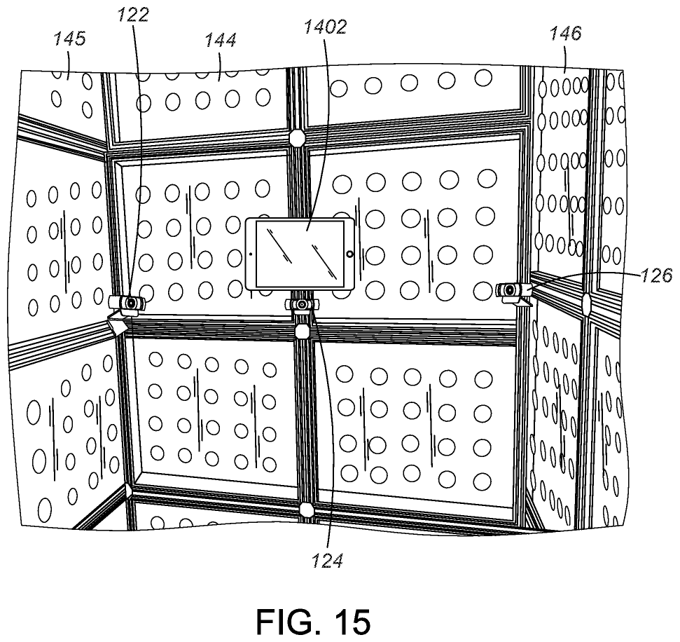

FIGS. 14 and 15 are shown from the same position relative to the kiosk 101. In FIG. 14 the door 150 is in an at least partially open state—at least more open than in FIG. 15. As such, a portion of the door 150 with an additional camera 132 is visible as well as the front three cameras 122, 124, 126. In contrast, in FIG. 15, the door 150 is in a more closed position, and not visible. FIG. 15 shows an example arrangement of the three front cameras 122, 124, 126.

Another difference between FIG. 14 and FIG. 15 is that FIG. 14 shows an embodiment including a display screen 1402. In some examples, the kiosk 101 can include the display screen 1402 mounted on a front wall 144. In some examples, the display screen 1402 can be mounted so that a center of a bottom edge of the display screen is close to one of the cameras 122, 124, 126, such as close to the center camera 124. In some examples, the display screen 1402 can be positioned at a height so that the center of the bottom edge of the display screen 1402 is not higher than 2 inches (5 centimeters), 4 inches (10 centimeters), or 6 inches (15 centimeters) above the center of one of the cameras 122, 124, 126. Placement of the display screen 1402 close to one of the cameras 122, 124, 126 encourages a user to look towards that particular camera and away from the second user interface 134. By encouraging the user to look toward one of the cameras, a higher-quality video interview can be captured that portrays the user as making eye contact with the viewer, engaging, confident, and direct. In some examples, the display screen 1402 can include the first user interface 133. In some examples, the display screen 1402 can display a live video of the user, such as a video feed from camera 124.

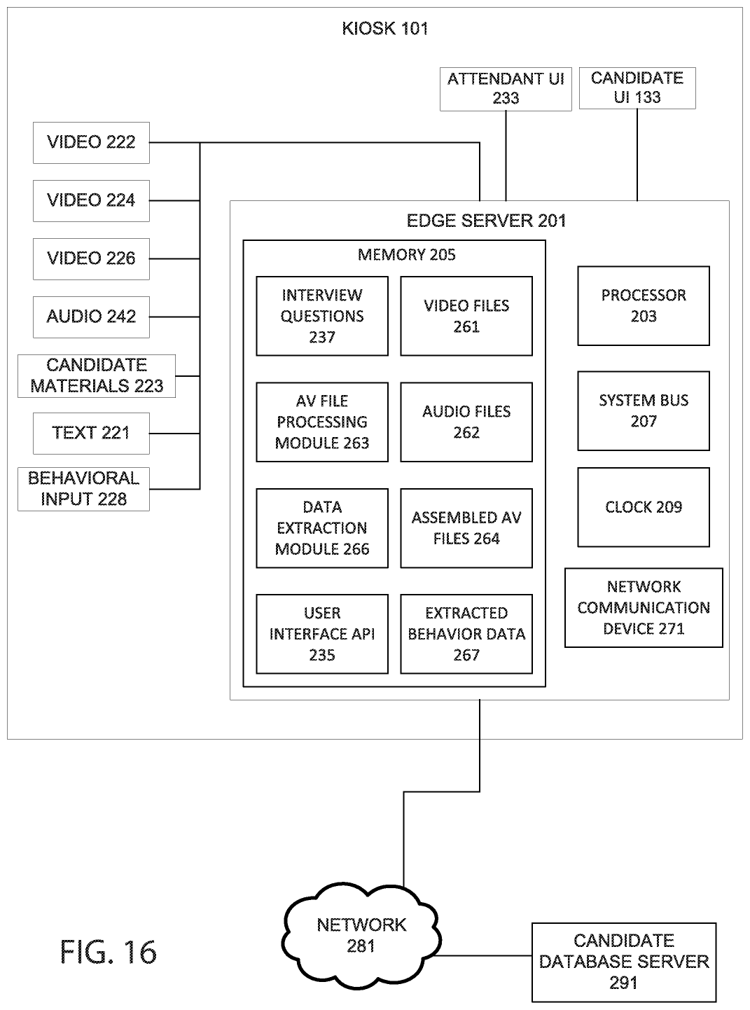

Schematic of Kiosk and Edge Server (FIG. 16)

FIG. 16 shows a schematic diagram of one example of the system. The kiosk 101 includes an edge server 201 that has a computer processor 203, a system bus 207, a system clock 209, and a non-transitory computer memory 205. The edge server 201 is configured to receive input from the video and audio devices of the kiosk and process the received inputs.

The kiosk 101 can further include the candidate user interface 133 in data communication with the edge server 201. An additional user interface 233 can be provided for a kiosk attendant. The attendant user interface 233 can be used, for example, to check in users, or to enter data about the users. The candidate user interface 133 and the attendant user interface 233 can be provided with a user interface application program interface (API) 235 stored in the memory 205 and executed by the processor 203. The user interface API 235 can access particular data stored in the memory 205, such as interview questions 237 that can be displayed to the individual 112 on in the user interface 133. The user interface API 235 can receive input from the individual 112 to prompt a display of a next question once the individual has finished answering a current question.

In some examples, one or more additional user interfaces 233 can be provided, such as for uploading a resume or other information about the candidate. In some examples, one or more user interfaces 233 can be disposed on the exterior of the kiosk, such as to allow use of the interface from outside of the kiosk. One example of such an exterior location for a user interface 233 is mounted on an exterior surface of front wall 144.

The system includes multiple types of data inputs. In one example, the camera 122 produces a video input 222, the camera 124 produces a video input 224, and the camera 126 produces a video input 226. The microphone 142 produces an audio input 242. The system also receives behavioral data input 228. The behavioral data input 228 can be from a variety of different sources. In some examples, the behavioral data input 228 is a portion of data received from one or more of the cameras 122, 124, 126. In other words, the system receives video data and uses it as the behavioral data input 228. In some examples, the behavioral data input 228 is a portion of data received from the microphone 142. In some examples, the behavioral data input 228 is sensor data from one or more depth sensors or infrared sensors provided on the cameras 122, 124, 126. The system can also receive text data input 221 that can include text related to the individual 112 and candidate materials 223 that can include materials related to the individual's job candidacy, such as a resume.

In some examples, the video inputs 222, 224, 226 are stored in the memory 205 of the edge server 201 as video files 261. In alternative examples, the video inputs 222, 224, 226 are processed by the processor 203, but are not stored separately. In some examples, the audio input 242 is stored as audio files 262. In alternative examples, the audio input 242 is not stored separately. The candidate materials input 223, text data input 221, and behavioral data input 228 can also be optionally stored or not stored as desired.

In some examples, the edge server 201 further includes a network communication device 271 that enables the edge server 201 to communicate with a remote network 281. This enables data that is received and/or processed at the edge server 201 to be transferred over the network 281 to a candidate database server 291.

The edge server 201 includes computer instructions stored on the memory 205 to perform particular methods. The computer instructions can be stored as software modules. As will be described below, the system can include an audiovisual file processing module 263 for processing received audio and video inputs and assembling the inputs into audiovisual files and storing the assembled audiovisual files 264. The system can include a data extraction module 266 that can receive one or more of the data inputs (video inputs, audio input, behavioral input, etc.) and extract behavior data 267 from the inputs and store the extracted behavior data 267 in the memory 205.

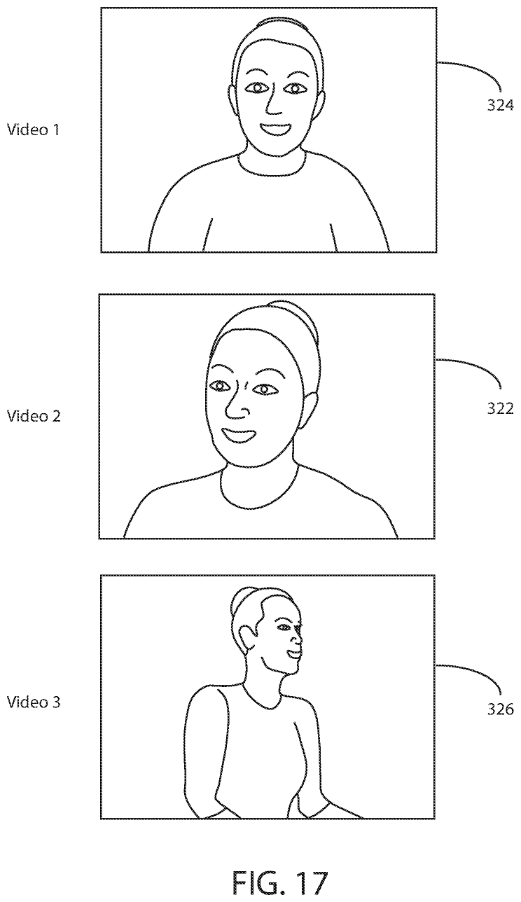

Automatically Creating Audiovisual Files from Two or More Video Inputs (FIGS. 17-21)

The disclosed system and method provide a way to take video inputs from multiple cameras and arrange them automatically into a single audiovisual file that cuts between different camera angles to create a visually interesting product.

FIG. 17 illustrates video frames of video inputs received from different cameras. In this example, video frame 324 is part of the video input 224 that is received from the second camera 124, which focuses on the individual 112 from a front and center angle. This video input is designated as “Video 1” or simply “Vid1.” The video frame 322 is part of the video input 222 from the first camera 122, which focuses on the individual 112 from the individual 112's left side. This video input is designated as “Video 2” or simply “Vid2.” The video frame 326 is part of the video input 226 from the third camera 126, which focuses on the individual 112 from the individual 112's right side. This video input is designated as “Video 3” or simply “Vid3.” These video inputs can be provided using any of a number of different types of video coding formats. These include but are not limited to MPEG-2 Part 2, MPEG-4 Part 2, H.264 (MPEG-4 Part 10), HEVC, and AV1.

Audio inputs 242 can also be provided using any of a number of different types of audio compression formats. These can include but are not limited to MP1, MP2, MP3, AAC, ALAC, and Windows Media Audio.

The system takes audiovisual clips recorded during the video interview and concatenates the audiovisual clips to create a single combined audiovisual file containing video of an individual from multiple camera angles. In some implementations, a system clock 209 creates a timestamp associated with the video inputs 222, 224, 226 and the audio input 242 that allows the system to synchronize the audio and video based on the timestamp. A custom driver can be used to combine the audio input with the video input to create an audiovisual file.

As used herein, an “audiovisual file” is a computer-readable container file that includes both video and audio. An audiovisual file can be saved on a computer memory, transferred to a remote computer via a network, and played back at a later time. Some examples of video encoding formats for an audiovisual file compatible with this disclosure are MP4 (mp4, m4a, mov); 3GP (3gp, 3gp2, 3g2, 3gpp, 3gpp2); WMV (wmv, wma); AVI; and QuickTime.

As used herein, an “audiovisual clip” is a video input combined with an audio input that is synchronized with the video input. For example, the system can record an individual 112 speaking for a particular length of time, such as 30 seconds. In a system that has three cameras, three audiovisual clips could be created from that 30 second recording: a first audiovisual clip can contain the video input 224 from Vid1 synchronized with the audio input 242 from t=0 to t=30 seconds. A second audiovisual clip can contain the video input 222 from Vid2 synchronized with the audio input 242 from t=0 to t=30 seconds. A third audiovisual clip can contain the video input 226 from Vid3 synchronized with the audio input 242 from t=0 to t=30 seconds. Audiovisual clips can be created by processing a video input stream and an audio input stream which are then stored as an audiovisual file. An audiovisual clip as described herein can be but is not necessarily stored in an intermediate state as a separate audiovisual file before being concatenated with other audiovisual clips. As will be described below, in some examples, the system will select one video input from a number of available video inputs and use that video input to create an audiovisual clip that will later be saved in an audiovisual file. In some examples, the unused video inputs may be discarded.

Audiovisual clips can be concatenated. As used herein, “concatenated” means adding two audiovisual clips together sequentially in an audiovisual file. For example, two audiovisual clips that are each 30 seconds long can be combined to create a 60-second long audiovisual file. In this case, the audiovisual file would cut from the first audiovisual clip to the second audiovisual clip at the 30 second mark.

During use, each camera in the system records an unbroken sequence of video and the microphone records an unbroken sequence of audio. An underlying time counter provides a timeline associated with the video and audio so that the video and audio can be synchronized.

In one example of the technology, the system samples the audio track to automatically find events that trigger the system to cut between video inputs when producing an audiovisual file. In one example, the system looks for segments in the audio track in which the volume is below a threshold volume. These will be referred to as low noise audio segments.

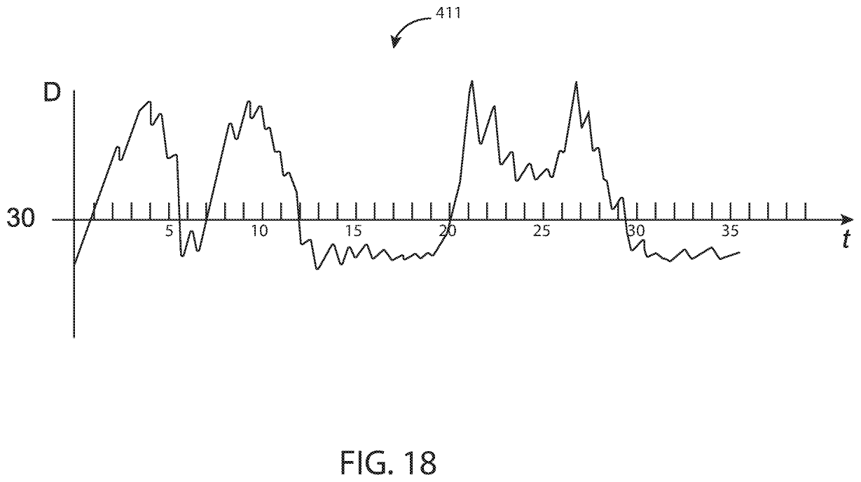

FIG. 18 is a graph 411 representing the audio volume in an audio track over time. The graph conceptually shows the audio volume of the audio input in decibels (D) versus time in seconds (t). In some examples, the system uses a particular threshold volume as a trigger to determine when to cut between the video inputs. For example, in FIG. 18, the threshold level is 30 decibels. One method of finding low noise audio segments is to calculate an average decibel level over a particular range of time, such as 4 seconds. If the average decibel level during that period of time is below the threshold level, the system will mark this as a low noise audio segment.

Applying this method to FIG. 18, the system computes the average (mean) volume over each four-second interval for the entire length of the audio track, in this case, in the range between t=0 and t=35. Consider an average decibel level over a four second interval between t=5 and t=9. In this case, although the volume falls below 30 decibels for a short period of time, the average volume over that four second period is greater than 30 decibels, and therefore this would not be considered a low noise audio segment. Over the four second interval from t=11 to t=15 seconds, the average volume is less than 30 decibels, and therefore this would be considered a low noise audio segment. In some examples, as soon as the system detects an event corresponding to a low noise audio segment, the system marks that time as being a trigger to switch between video inputs.

In some examples, the system marks the beginning and end of the low noise audio segments to find low noise audio segments of a particular length. In this example, the system computes the average (mean) volume over each four second interval, and as soon the average volume is below the threshold volume (in this case 30 decibels), the system marks that interval as corresponding to the beginning of the low noise audio segment. The system continues to sample the audio volume until the average audio volume is above the threshold volume. The system then marks that interval as corresponding to the end of the low noise audio segment.

The system uses the low noise audio segments to determine when to switch between camera angles. After finding and interval corresponding to the beginning or end of the low noise audio segments, the system determines precisely at which time to switch. This can be done in a number of ways, depending upon the desired result.

In the example of FIG. 18, the system could determine that the average volume of the four second interval between =10 and t=12 drops below the threshold volume. The system could use the end of that interval (t=12) to be the time to switch. Alternatively, the system could determine that the average volume of the four-second interval between t=18 and t=22 increases above the threshold volume, and determine that the beginning of that interval (t=18) as the time to switch. The system could also use the midpoint of the beginning and end of the intervals to switch (i.e., midway between t=12 and t=18). Other methods of determining precisely when in the timeline to make the switch are possible and are within the scope of the technology.

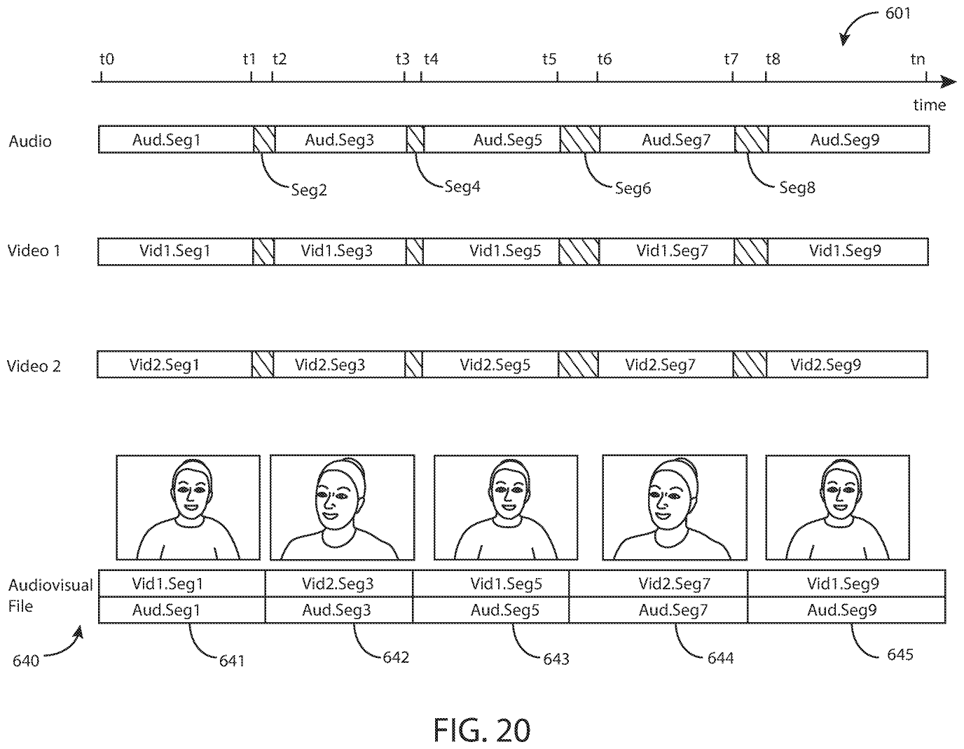

In some examples, the system is configured to discard portions of the video and audio inputs that correspond to a portion of the low noise audio segments. This eliminates dead air and makes the audiovisual file more interesting for the viewer. In some examples, the system only discards audio segments that our at least a predetermined length of time, such as at least 2 seconds, at least 4 seconds, at least 6 seconds, at least 8 seconds, or at least 10 seconds. This implementation will be discussed further in relation to FIG. 20.

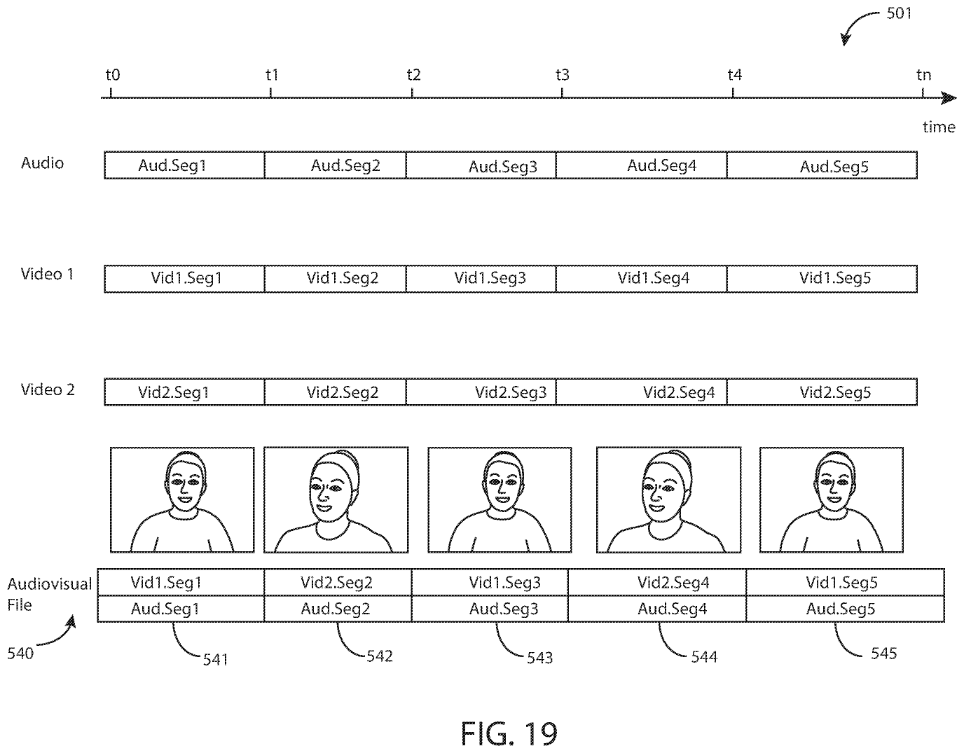

Automatically Concatenating Audiovisual Clips (FIG. 19)

FIG. 19 illustrates a system and method for automatically creating a combined audiovisual file containing video images from two or more video inputs. For the sake of simplicity, only two video inputs are illustrated in FIG. 19. It should be understood, however, that the method and system could be adapted to any number of video inputs.

The system includes two video inputs: Video 1 and Video 2. The system also includes an Audio input. In the example of FIG. 19, the video inputs and the audio input are recorded simultaneously. The two video inputs and the audio input are each recorded as an unbroken sequence. A time counter, such as the system clock 209, provides a timeline 501 that enables a time synchronization of the two video inputs and the audio input. The recording begins at time to and ends at time tₙ.

In the example of FIG. 19, the system samples the audio track to determine low noise audio segments. For example, the system can use the method as described in relation to FIG. 18; however, other methods of determining low noise audio segments are contemplated and are within the scope of the disclosed technology.

Sampling the audio track, the system determines that at time t₁, a low noise audio event occurred. The time segment between t=t₀ and t=t₁ is denoted as Seg1. To assemble a combined audiovisual file 540, the system selects an audiovisual clip 541 combining one video input from Seg1 synchronized with the audio from Seg1, and saves this audiovisual clip 541 as a first segment of the audiovisual file 540—in this case, Vid1.Seg1 (Video 1 Segment 1) and Aud.Seg1 (audio Segment 1). In some examples, the system can use a default video input as the initial input, such as using the front-facing camera as the first video input for the first audiovisual clip. In alternative examples, the system may sample content received while the video and audio are being recorded to prefer one video input over another input. For example, the system may use facial or gesture recognition to determine that one camera angle is preferable over another camera angle for that time segment. Various alternatives for choosing which video input to use first are possible and are within the scope of the technology.

The system continues sampling the audio track, and determines that at time t₂, a second low noise audio event occurred. The time segment between t=t₁ and t=t₂ is denoted as Seg2. For this second time segment, the system automatically switches to the video input from Video 2, and saves a second audiovisual clip 542 containing Vid2.Seg2 and Aud.Seg2. The system concatenates the second audiovisual clip 542 and the first audiovisual clip 541 in the audiovisual file 540.

The system continues sampling the audio track, and determines that at time t₃, a third low noise audio event occurred. The time segment between t=t₂ and t=t₃ is denoted as Seg3. For this third time segment, the system automatically cuts back to the video input from Video 1, and saves a third audiovisual clip 543 containing Vid1.Seg3 and Aud.Seg3. The system concatenates the second audiovisual clip 542 and the third audiovisual clip 543 in the audiovisual file 540.

The system continues sampling the audio track, and determines that at time t₄, a fourth low noise audio event occurred. The time segment between t=t₃ and t=t₄ is denoted as Seg4. For this fourth time segment, the system automatically cuts back to the video input from Video 2, and saves a fourth audiovisual clip 544 containing Vid2.Seg4 and Aud.Seg4. The system concatenates the third audiovisual clip 543 and the fourth audiovisual clip 544 in the audiovisual file 540.

The system continues sampling the audio track, and determines that no additional low noise audio events occur, and the video input and audio input stop recording at time tₙ. The time segment between t=t₄ and t=tₙ is denoted as Seg5. For this fifth time segment, the system automatically cuts back to the video input from Video 1, and saves a fifth audiovisual clip 545 containing Vid1.Seg5 and Aud.Seg5. The system concatenates the fourth audiovisual clip 544 and the fifth audiovisual clip 545 in the audiovisual file 540.

In some examples, audio sampling and assembling of the combined audiovisual file is performed in real-time as the video interview is being recorded. In alternative examples, the video input and audio input can be recorded, stored in a memory, and processed later to create a combined audiovisual file. In some examples, after the audiovisual file is created, the raw data from the video inputs and audio input is discarded.

Automatically Removing Pauses and Concatenating Audiovisual Clips (FIG. 20)

In another aspect of the technology, the system can be configured to create combined audiovisual files that remove portions of the interview in which the subject is not speaking. FIG. 20 illustrates a system and method for automatically creating a combined audiovisual file containing video images from two or more video input, where a portion of the video input and audio input corresponding to low noise audio segments are not included in the combined audiovisual file. For the sake of simplicity, only two video inputs are illustrated in FIG. 20. It should be understood, however, that the method and system could be adapted to any number of video inputs.

In the example of FIG. 20, the system includes a video input Video 1 and Video 2. The system also includes an Audio input. The video inputs and the audio input are recorded simultaneously in an unbroken sequence. A time counter, such as the system clock 209, provides a timeline 601 that enables a time synchronization of the two video inputs and the audio input. The recording begins at time to and ends at time tₙ.

As in the example of FIG. 19, the system samples the audio track to determine low noise audio segments. In FIG. 20, the system looks for the beginning and end of low noise audio segments, as described above with relation to FIG. 18. Sampling the audio track, the system determines that at time t₁, a low noise audio segment begins, and at time t₂, the low noise audio segment ends. The time segment between t=t₀ and t=t₁ is denoted as Seg1. To assemble a combined audiovisual file 640, the system selects an audiovisual clip 641 combining one video input from Seg1 synchronized with the audio from Seg1, and saves this audiovisual clip 641 as a first segment of the audiovisual file 640—in this case, Vid1.Seg1 (Video 1 Segment 1) and Aud.Seg1 (audio Segment 1). The system then disregards the audio inputs and video inputs that occur during Seg2, the time segment between t=t₁ and t=t₂.

The system continues sampling the audio track, and determines that at time t₃, a second low noise audio segment begins, and at time t₄, the second low noise audio segment ends. The time segment between t=t₂ and t=t₃ is denoted as Seg3. For this time segment, the system automatically switches to the video input from Video 2, and saves a second audiovisual clip 642 containing Vid2.Seg3 and Aud.Seg3. The system concatenates the second audiovisual clip 642 and the first audiovisual clip 641 in the audiovisual file 640.

The system continues sampling the audio input to determine the beginning and end of further low noise audio segments. In the example of FIG. 20, Seg6 is a low noise audio segment beginning at time t₅ and ending at time t₆. Seg 8 is a low noise audio segment beginning at time t₇ and ending at time t₈. The system removes the portions of the audio input and video inputs that fall between the beginning and end of the low noise audio segments. At the same time, the system automatically concatenates retained audiovisual clips, switching between the video inputs after the end of each low noise audio segment. The system concatenates the audiovisual clips 643, 644, and 645 to complete the audiovisual file 640. The resulting audiovisual file 640 contains audio from segments 1, 3, 5, 7, and 9. The audiovisual file 640 does not contain audio from segments 2, 4, 6, or 8. The audiovisual file 640 contains alternating video clips from Video 1 and Video 2 that switch between the first video input and the second video input after each low noise audio segment.

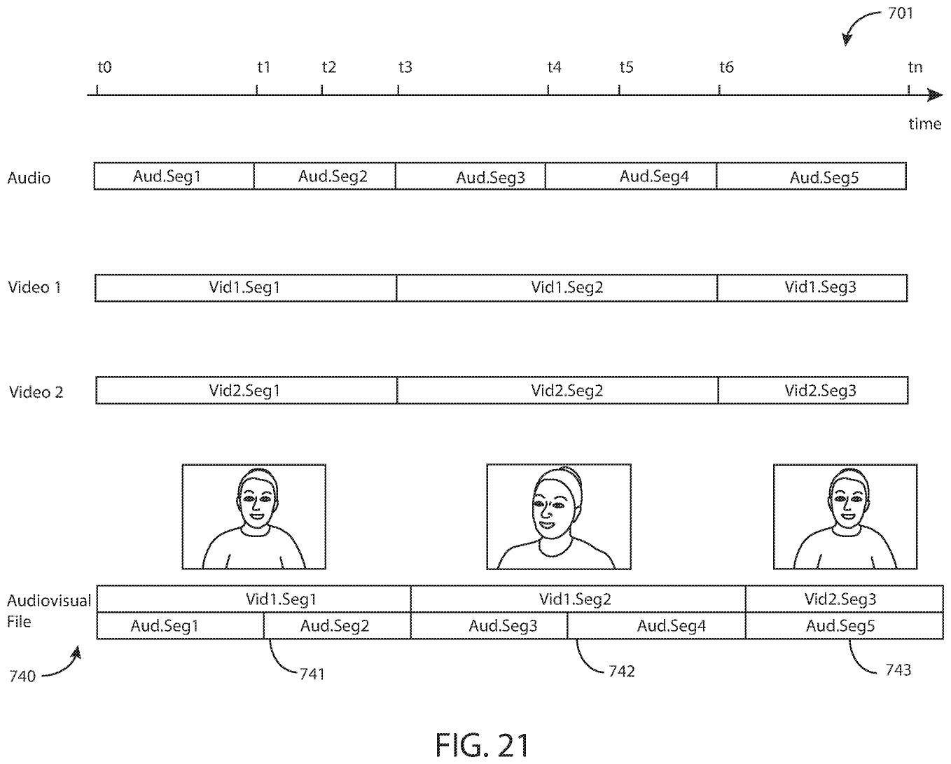

Automatically Concatenating Audiovisual Clips with Camera Switching in Response to Switch-Initiating Events (FIG. 21)

In another aspect of the technology, the system can be configured to switch between the different video inputs in response to events other than low noise audio segments. These events will be generally categorized as switch-initiating events. A switch-initiating event can be detected in the content of any of the data inputs that are associated with the timeline. “Content data” refers to any of the data collected during the video interview that can be correlated or associated with a specific time in the timeline. These events are triggers that the system uses to decide when to switch between the different video inputs. For example, behavioral data input, which can be received from an infrared sensor or present in the video or audio, can be associated with the timeline in a similar manner that the audio and video images are associated with the timeline. Facial recognition data, gesture recognition data, and posture recognition data can be monitored to look for switch-initiating events. For example, if the candidate turns away from one of the video cameras to face a different video camera, the system can detect that motion and note it as a switch-initiating event. Hand gestures or changes in posture can also be used to trigger the system to cut from one camera angle to a different camera angle.

As another example, the audio input can be analyzed using speech to text software, and the resulting text can be used to find keywords that trigger a switch. In this example, the words used by the candidate during the interview would be associated with a particular time in the timeline.

Another type of switch-initiating event can be the passage of a particular length of time. A timer can be set for a number of seconds that is the maximum desirable amount of time for a single segment of video. For example, an audiovisual file can feel stagnant and uninteresting if the same camera has been focusing on the subject for more than 90 seconds. The system clock can set a 90 second timer every time that a camera switch occurs. If it has been greater than 90 seconds since the most recent switch-initiating event, expiration of the 90 second timer can be used as the switch-initiating event. Other amounts of time could be used, such as 30 seconds, 45 seconds, 60 seconds, etc., depending on the desired results.

Conversely, the system clock can set a timer corresponding to a minimum number of seconds that must elapse before a switch between two video inputs. For example, the system could detect multiple switch-initiating events in rapid succession, and it may be undesirable to switch back-and-forth between two video inputs too quickly. To prevent this, the system clock could set a timer for 30 seconds, and only register switch-initiating events that occur after expiration of the 30 second timer. Though resulting combined audiovisual file would contain audiovisual clip segments of 30 seconds or longer.

Another type of switch-initiating event is a change between interview questions that the candidate is answering, or between other segments of a video recording session. In the context of an interview, the user interface API 235 (FIG. 16) can display interview questions so that the individual 112 can read each interview question and then respond to it verbally. The user interface API can receive input, such as on a touch screen or input button, to indicate that one question has been answered, and prompt the system to display the next question. The prompt to advance to the next question can be a switch-initiating event.

Turning to FIG. 21, the system includes two video inputs: Video 1 and Video 2. The system also includes an Audio input. In the example of FIG. 21, the video inputs and the audio input are recorded simultaneously. The two video inputs and the audio input are each recorded as an unbroken sequence. A time counter, such as the system clock 209, provides a timeline 701 that enables a time synchronization of the two video inputs and the audio input. The recording begins at time to and ends at time tₙ. In some examples, the system of FIG. 21 further includes behavioral data input associated with the timeline 701.

In the example of FIG. 21, the system automatically samples the audio input for low noise audio segments in addition to detecting switch-initiating events. The system can sample the audio input using the method as described in relation to FIG. 18; however, other methods of determining low noise audio segments are contemplated and are within the scope of the disclosed technology.

In FIG. 21, the audio track is sampled in a manner similar to that of FIG. 19. The system determines that at time t₁, a low noise audio event occurred. The time segment between t=t₀ and t=t₁ is denoted as Aud.Seg 1. However, no switch-initiating event was detected during Aud.Seg1. Therefore, unlike the system of FIG. 19, the system does not switch video inputs.

At time t₂, the system detects a switch-initiating event. However, the system does not switch between camera angles at time t₂, because switch-initiating events can occur at any time, including during the middle of a sentence. Instead, the system in FIG. 21 continues sampling the audio input to find the next low noise audio event. This means that a switch between two camera angles is only performed after two conditions have been met: the system detects a switch-initiating event, and then, after the switch-initiating event, the system detects a low noise audio event.

In some examples, instead of continuously sampling the audio track for low noise audio events, the system could wait to detect a switch-initiating event, then begin sampling the audio input immediately after the switch-initiating event. The system would then cut from one video input to the other video input at the next low noise audio segment.

At time t₃, the system determines that another low noise audio segment has occurred. Because this low noise audio segment occurred after a switch-initiating event, the system begins assembling a combined audiovisual file 740 by using an audiovisual clip 741 combining one video input (in this case, Video 1) with synchronized audio input for the time segment t=t₀ through t=t₃.

The system then waits to detect another switch-initiating event. In the example of FIG. 21, the system finds another low noise audio event at t₄, but no switch-initiating event has yet occurred. Therefore, the system does not switch to the second video input. At time t₅, the system detects a switch-initiating event. The system then looks for the next low noise audio event, which occurs at time t₆. Because time t₆ is a low noise audio event that follows a switch-initiating event, the system takes the audiovisual clip 742 combining video input from Video 2 and audio input from the time segment from t=t₃ to t=t₆. The audiovisual clip 741 is concatenated with the audiovisual clip 742 in the audiovisual file 740.

The system then continues to wait for a switch-initiating event. In this case, no switch-initiating event occurs before the end of the video interview at time tₙ. The audiovisual file 740 is completed by concatenating an alternating audiovisual clip 743 containing video input from Video 1 to the end of the audiovisual file 740.

The various methods described above can be combined in a number of different ways to create entertaining and visually interesting audiovisual interview files. Multiple video cameras can be used to capture a candidate from multiple camera angles. Camera switching between different camera angles can be performed automatically with or without removing audio and video corresponding to long pauses when the candidate is not speaking. Audio, video, and behavioral inputs can be analyzed to look for content data to use as switch-initiating events, and/or to decide which video input to use during a particular segment of the audiovisual file. Some element of biofeedback can be incorporated to favor one video camera input over the others.

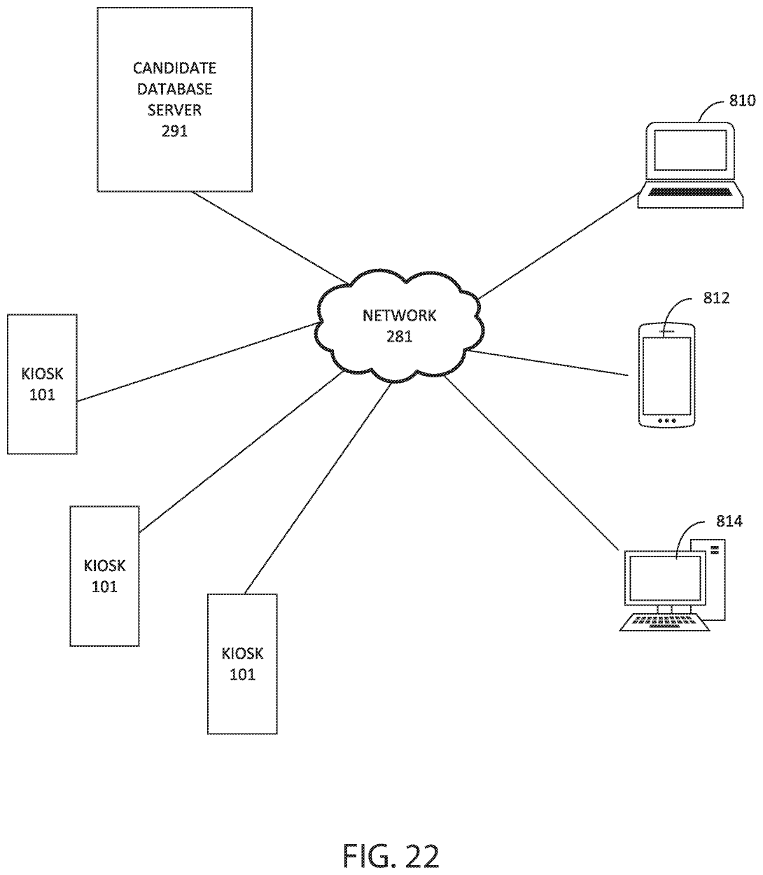

Networked Video Kiosk System (FIG. 22)

In a further aspect, the system provides a networked system for recording, storing, and presenting audiovisual interviews of multiple employment candidates at different geographic sites. As seen in FIG. 22, the system can use multiple kiosks 101 at separate geographic locations. Each kiosk 101 can be similar to kiosk 101 shown in FIG. 16, with multiple video cameras, a local edge server, etc. Each of the kiosks 101 can be in data communication with a candidate database server 291 via a communication network 281 such as the Internet. Audiovisual interviews that are captured at the kiosks 101 can be uploaded to the candidate database server 291 and stored in a memory for later retrieval. Users, such as recruiters or hiring managers, can request to view candidate profiles and video interviews over the network 281. The system can be accessed by multiple devices, such as laptop computer 810, smart phone or tablet 812, and personal computer 814.

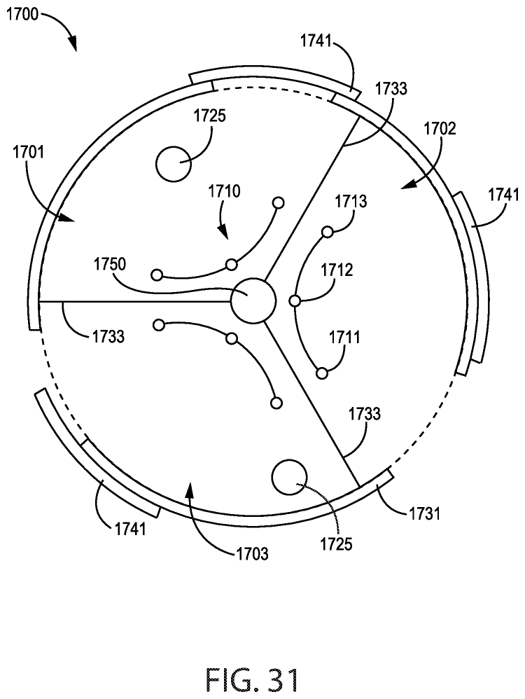

In addition or in the alternative, any of the individual kiosks 101 in a networked system, such as shown in FIG. 22, can be replaced by alternate kiosk 1700 or alternate kiosk 1901, described herein with respect to FIGS. 31-33.

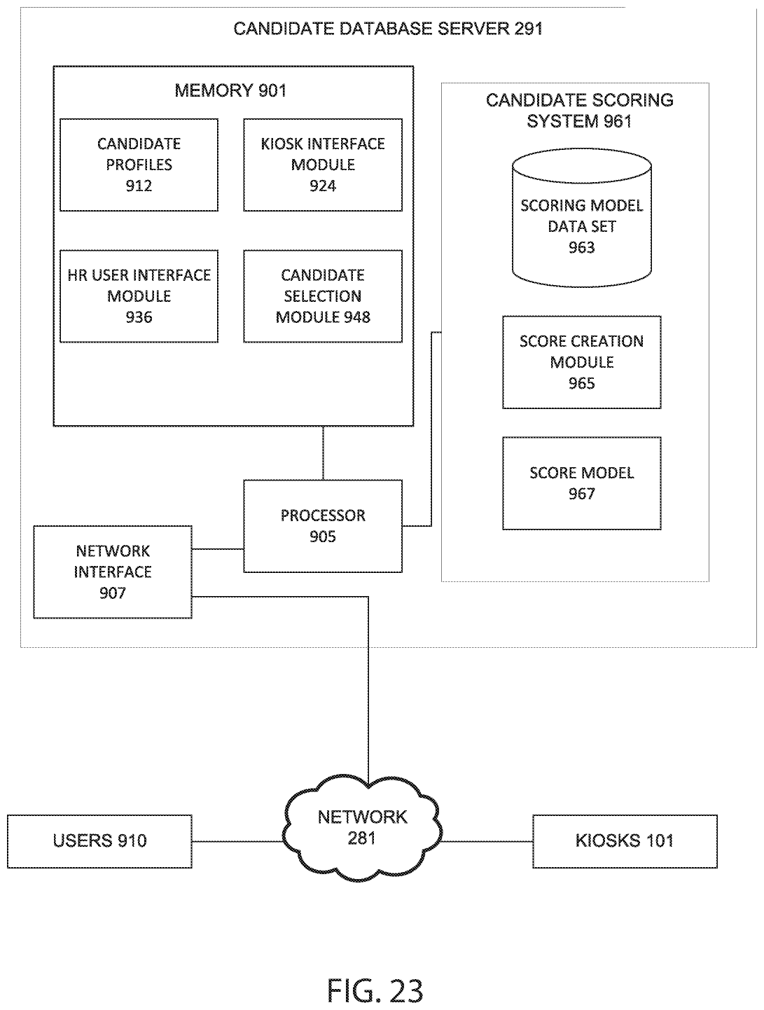

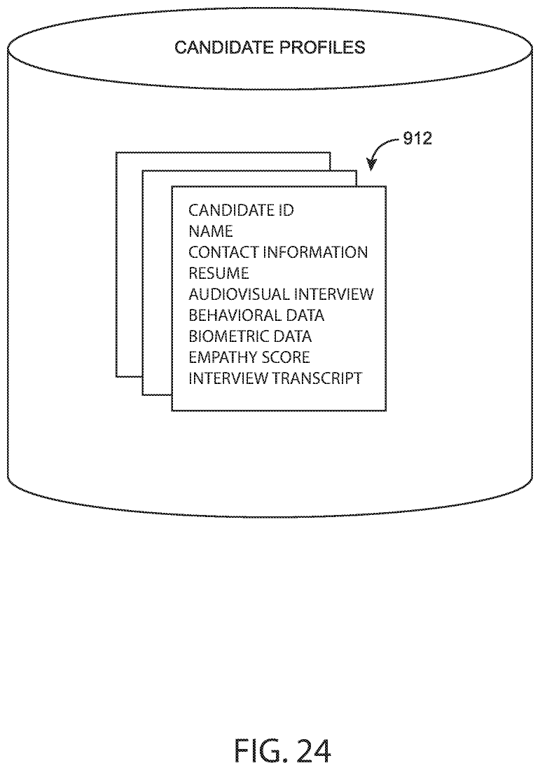

Candidate Database Server (FIGS. 23-24)

FIG. 23 is a schematic view of a candidate database server system according to some examples. Candidate database server 291 has a processor 905, a network communication interface 907, and a memory 901. The network communication interface 907 enables the candidate database server 291 to communicate via the network 281 with the multiple kiosks 101 and multiple users 910, such as hiring managers. The users 910 can communicate with the candidate database server 291 via devices such as the devices 810, 812, and 814 of FIG. 22.

The candidate database server 291 stores candidate profiles 912 for multiple employment candidates. FIG. 24 is a schematic view of candidate profiles 912. Each candidate in the system has a candidate profile. The candidate profiles 912 store data including but not limited to candidate ID, candidate name, contact information, resume text, audiovisual interview file, extracted behavioral data, which can include biometric data, a calculated empathy score, an interview transcript, and other similar information relevant to the candidate's employment search.

The memory 901 of the candidate database server 291 stores a number of software modules containing computer instructions for performing functions necessary to the system. A kiosk interface module 924 enables communication between the candidate database server 291 and each of the kiosks 101 via the network 281. A human resources (HR) user interface module 936 enables users 910 to view information for candidates with candidate profiles 912. As will be discussed further below, a candidate selection module 948 processes requests from users 910 and selects one or more particular candidate profiles to display to the user in response to the request.

In another aspect, the system further includes a candidate scoring system 961 that enables scoring of employment candidates based on information recorded during a candidate's video interview. As will be discussed further below, the scoring system 961 includes a scoring model data set 963 that is used as input data for creating the model. The data in the model data set 963 is fed into the score creation module 965, which processes the data to determine variables that correlate to a degree of empathy. The result is a score model 967, which is stored for later retrieval when scoring particular candidates.

Although FIG. 23 depicts the system with a single candidate database server 291, it should be understood that this is a representative example only. The various portions of the system could be stored in separate servers that are located remotely from each other. The data structures presented herein could furthermore be implemented in a number of different ways and are not necessarily limited to the precise arrangement described herein.

Recording Audiovisual Interviews

In some examples, audiovisual interviews for many different job candidates can be recorded in a kiosk such as described above. To begin the interview, the candidate sits or stands in front of an array of video cameras and sensors. The height and position of each of the video cameras may be adjusted to optimally capture the video and the behavioral data input. In some examples, a user interface such as a tablet computer is situated in front of the candidate. The user interface can be used to present questions to the candidate.

In some examples, each candidate answers a specific number of predetermined questions related to the candidate's experience, interests, etc. These can include questions such as: Why did you choose to work in your healthcare role? What are three words that others would use to describe your work? How do you handle stressful work situations? What is your dream job? Tell us about a time you used a specific clinical skill in an urgent situation? Why are you a great candidate choice for a healthcare employer?

The candidate reads the question on the user interface, or an audio recording of the question can be played to the candidate. In response, the candidate provides a verbal answer as though the candidate were speaking in front of a live interviewer. As the candidate is speaking, the system is recording multiple video inputs, audio input, and behavioral data input. A system clock can provide a time synchronization for each of the inputs, allowing the system to precisely synchronize the multiple data streams. In some examples, the system creates a timestamp at the beginning and/or end of each interview question so that the system knows which question the individual was answering at a particular time. In some examples, the video and audio inputs are synchronized and combined to create audiovisual clips. In some examples, each interview question is saved as its own audiovisual file. So for example, an interview that posed five questions to the candidate would result in five audiovisual files being saved for the candidate, one audiovisual file corresponding to each question.

In some examples, body posture is measured at the same time that video and audio are being recorded while the interview is being conducted, and the position of the candidate's torso in three-dimensional space is determined. This is used as a gauge for confidence, energy, and self-esteem, depending on the question that the candidate is answering. One example of such a system is provided below.

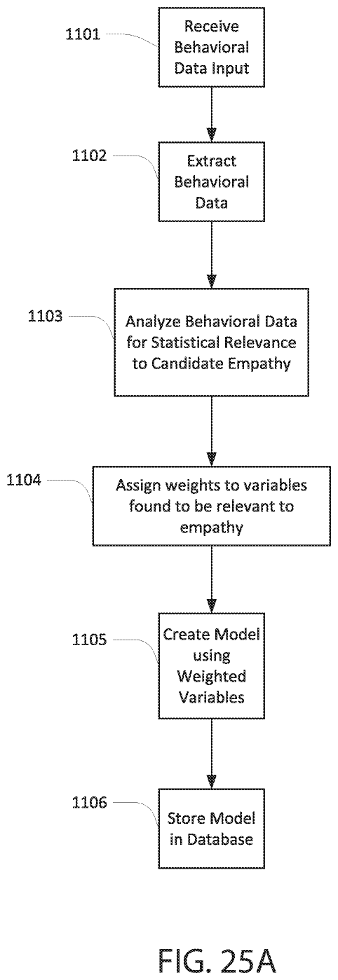

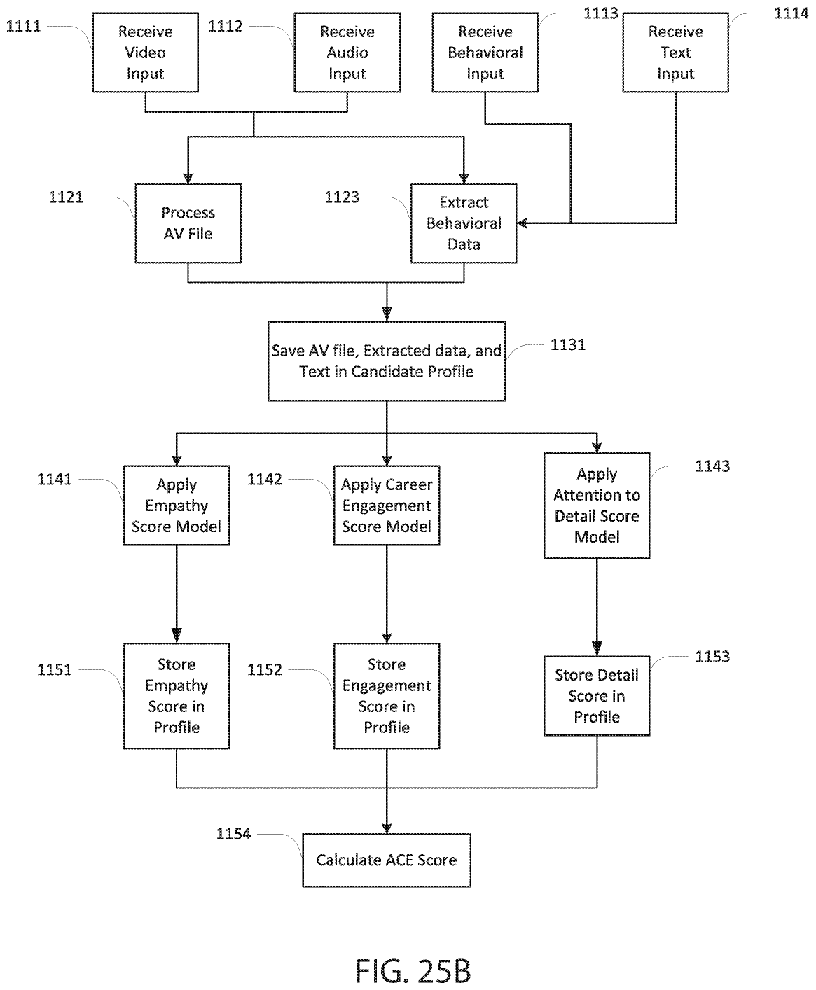

Method of Building an Empathy Score Model (FIG. 25A)

FIG. 25A illustrates one example of a method for building an empathy score model. The method can be performed in conjunction with technology described above related to a multi-camera kiosk setup capable of concatenating audiovisual files from multiple video inputs. However, other alternatives are possible and are within the scope of the employment candidate empathy scoring system described herein. The method can be performed in connection with recording an audiovisual interviews of multiple job candidates. The method receives a number of different types of data recorded during each interview. In some examples, individuals that are interviewed are chosen from among a pool of candidates having qualities that are known to be related to a particular degree of empathy. In some examples, the pool of candidates is known to have a high degree of empathy. In alternative examples, the pool of candidates is drawn from the general population, in which case, it would be expected that the pool of candidates would have a wide range of degrees of empathy.

In some examples, empathy score models are created for different individual roles within a broader employment field. For example, an ideal candidate benchmark for a healthcare administrator could be very different from the benchmark for an employee that has direct hands-on contact with patients.

By taking the measurements of ideal candidates, we have a base line that can be utilized. We can then graph the changes and variations for new candidates by the specific interview questions we have chosen. By controlling for time and laying over the other candidates' data, a coefficient of variation can be created per question and overall. Depending on the requirements of the position we are trying to fill, we can select candidates who appear more competent in a given area, such as engagement, leadership or empathy.

Turning to FIG. 25A, in step 1101, behavioral data input for multiple individuals is received. In some examples, the behavioral data input is video data. In some examples, the behavioral data input is audio data. In some examples, the behavioral data input is sensor data, such as data output from an infrared sensor. In some examples, the behavioral data input is text data, such as resume text, written text input, or text extracted from recorded speech using text to speech software. The behavioral data input can be one type of data, or multiple different types of data can be used as behavioral data input.

Each individual within the pool of candidates provides behavioral data. In some examples, the pool of candidates is a predetermined size to effectively represent a general population, while remaining small enough to efficiently analyze the data. For example, the sample size of the pool of candidates can be at least 30 individuals, at least 100 individuals, at least 200 individuals, at least 300 individuals or at least 400 individuals. In some examples, the sample size of the pool candidates can be less than 500 individuals, less than 400 individuals, less than 300 individuals, less than 200 individuals, or less than 100 individuals. In some examples, the pool of candidates can be between about 30 and 500 individuals, between about 100 and 400 individuals, or between about 100 and 300 individuals. In some examples, the sample size of the pool of candidates can be approximately 300 individuals.

In step 1102, behavioral data is extracted from the behavioral data input. Extraction of the behavioral data is accomplished differently depending on which type of input is used (video, audio, sensor, etc.). In some examples, multiple variables are extracted from each individual type of behavioral data. For example, a single audio stream can be analyzed for multiple different types of characteristics, such as voice pitch, tone, cadence, the frequency with which certain words are used, length of time speaking, or the number of words per minute spoken by the individual. Alternatively or in addition, the behavioral data can be biometric data, including but not limited to facial expression data, body posture data, hand gesture data, or eye movement data. Other types of behavioral data are contemplated and are within the scope of the technology.

In step 1103, the behavioral data is analyzed for statistical relevance to an individual's degree of empathy. For example, regression analysis can be performed on pairs of variables or groups of variables to provide a trend on specific measures of interest. In some cases, particular variables are not statistically relevant to degree of empathy. In some cases, particular variables are highly correlated to a degree of empathy. After regression analysis, a subset of all of the analyzed variables are chosen as having statistical significance to a degree of empathy. In step 1104, each of the variables found to be relevant to the individual's degree of empathy is given a weight. The weighted variables are then added to an empathy score model in step 1105, and the empathy score model is stored in a database in step 1106, to be retrieved later when analyzing new candidates.

Method of Applying an Empathy Score Model (FIG. 25B)

Turning to FIG. 25B, in some examples, a method of applying an empathy score model is provided. The method can be performed in conjunction with technology described above related to a multi-camera kiosk set up capable of concatenating audiovisual files from multiple video inputs. Other alternatives are possible and are within the scope of the employment candidate empathy scoring system. In steps 1111-1114, a number of different types of data are received. In some examples, the data is recorded during video interviews of multiple job candidates. For each job candidate the system receives: video data input 1111, audio data input 1112, and behavioral data input 1113. Optionally, the system receives text data input 1114. In some examples, the video data input 1111, audio data input 1112, and behavioral data input 1113 is recorded simultaneously. In some examples, these data inputs are associated with a timestamp provided by a system clock that indicates a common timeline for each of the data inputs 1111-1113. In some examples, the data inputs that are received are of the same type that were determined to have statistical significance to a degree of empathy of a candidate in steps 1103-1104 of FIG. 25A.

In step 1121, the system takes the video data input 1111 and the audio data input 1112 and combines them to create an audiovisual file. In some examples, the video data input 1111 includes video data from multiple video cameras. In some examples, the video data input 1111 from multiple video cameras is concatenated to create an audiovisual interview file that cuts between video images from multiple cameras as described in relation to FIGS. 17-21. In some examples, the video data input 1111 and the audio data input 1112 is synchronized to create a single audiovisual file. In some examples, the video data input 1111 is received from a single video camera, and be audiovisual file comprises the video data from the single video camera and the audio data input 1112 that are combined to create a single audiovisual file.

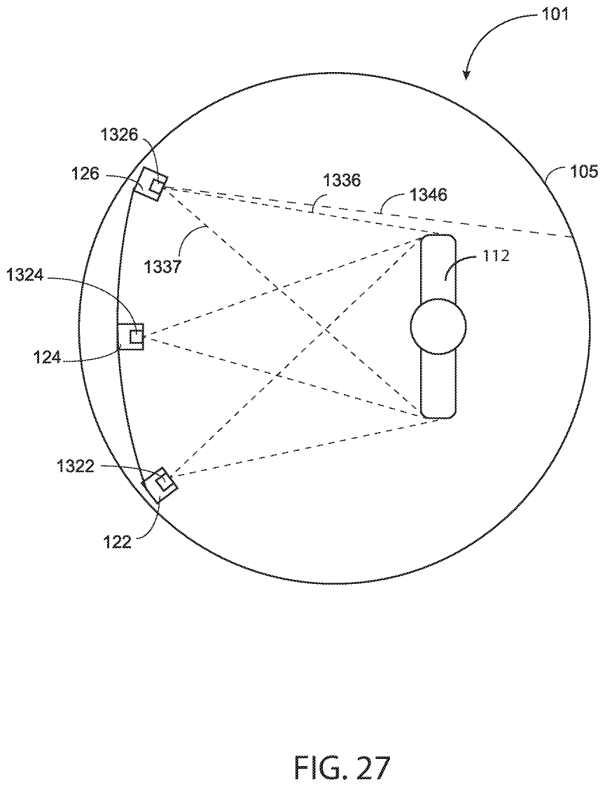

In step 1123, behavioral data is extracted from the data inputs received in steps 1111-1114. The behavioral data is extracted in a manner appropriate to the particular type of data input received. For example, if the behavioral data is received from an infrared sensor, the pixels recorded by the infrared sensor are analyzed to extract data relevant to the candidate's behavior while the video interview was being recorded. One such example is provided below in relation to FIGS. 27-29, although other examples are possible and are within the scope of the technology.

In step 1131, the audiovisual file, the extracted behavioral data, and the text (if any) is saved in a profile for the candidate. In some examples, this data is saved in a candidate database as shown and described in relation to FIG. 23.

In step 1141, the information saved in the candidate profile in the candidate database is applied to the empathy score model. Application of the empathy score model results in an empathy score for the candidate based on the information received in steps 1111-1114. In step 1151, the empathy score is then saved in the candidate profile of that particular individual.

Optionally, a career engagement score is applied in step 1142. The career engagement score is based on a career engagement score model that measures the candidate's commitment to advancement in a career. In some examples, the career engagement score receives text from the candidate's resume received in step 1114. In some examples, the career engagement score receives text extracted from an audio input by speech to text software. The career engagement score model can be based, for example, in the number of years that the candidate has been in a particular industry, or the number of years that the candidate has been in a particular job. In some examples, keywords extracted from the audio interview of the candidate can be used in the career engagement score. In examples in which the candidate receives a career engagement score, the career engagement score is stored in the candidate profile in step 1152.

In some examples, the system provides the candidate with an attention to detail score in step 1143. The attention to detail score can be based, for example, on text received from the text data input step 1114. The input to the attention to detail score model can be information based on a questionnaire received from the candidate. For example, the candidate's attention to detail can be quantitatively measured based on the percentage of form fields that are filled out by the candidate in a pre-interview questionnaire. The attention to detail score can also be quantitatively measured based on the detail provided in the candidate's resume. Alternatively or in addition, the attention to detail score can be related to keywords extracted from the audio portion of a candidate interview using speech to text. In step 1153, the attention to detail score is stored in the candidate's profile.

Optionally, the candidate's empathy score, career engagement score, and attention to detail score can be weighted to create a combined score incorporating all three scores at step 1154. This can be referred to as an “ACE” score (Attention to detail, Career engagement, Empathy). In some examples, each of the three scores stored in steps 1151-1153 are stored individually in a candidate's profile. These three scores can each be used to assess a candidate's appropriateness for a particular position. In some examples, different employment openings weight the three scores differently.

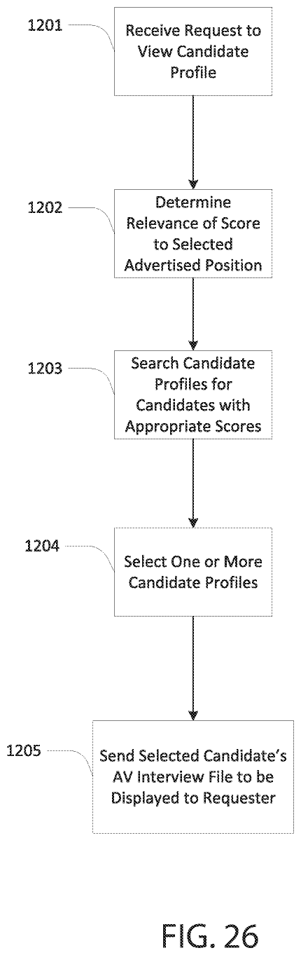

Method of Selecting a Candidate Profile in Response to a Request (FIG. 26)

FIG. 26 shows a method for using scored candidate profiles within a candidate database to select particular candidates to show to a user in response to a query to view candidate profiles. In a system that manages hundreds if not thousands of candidate profiles for different employment candidates, selecting one or more candidate video interviews to display to a hiring manager is time consuming and labor intensive if done manually. Furthermore, in some instances only a portion of a video interview is desired to be shown to a hiring manager. Automating the process of selecting which candidates to display to the hiring manager, and which particular video for each candidate should be displayed, improves the efficiency of the system and speeds up the cycle of recording the video interviews, showing the video interviews to the hiring manager, and ultimately placing the employment candidate in a job.

The method of FIG. 26 can be used in conjunction with the methods described in relation to the FIGS. 25A-25B. In step 1201, a request is received over a network from a user such as a human resources manager. The network can be similar to that described in relation to FIG. 22. The user can query the system via a number of user devices, including devices 810-814. However, the technology should not be interpreted as being limited to the system shown in FIG. 22. Other system configurations are possible and are within the scope of the present technology.

The request received in step 1201 can include a request to view candidates that conform to a particular desired candidate score as determined in steps 1151-1153. In step 1202, a determination is made of the importance of an empathy score to the particular request received in step 1201. For example, if the employment opening for which a human resources manager desires to view candidate profiles is related to employment in an emergency room or a hospice setting, it may be desired to select candidates with empathy scores in a certain range. In some examples, the request received in step 1201 indicates a request that includes a desired range of empathy scores. In some example, the desired range of empathy scores is within the highest 50% of candidates. In some example, the desired range of empathy scores is within the highest 25% of candidates. In some examples, the desired range of empathy scores is when in the highest 15% of candidates or 10% candidates.

Alternatively, in some examples, the request received in step 1201 includes a request to view candidates for employment openings that do not require a particular degree of empathy. This would include jobs in which the employee does not interact with patients. Optionally, for candidates who do not score within the highest percentage of candidates in the group, these candidates can be targeted for educational programs that will increase these candidates' empathy levels.

In step 1203, candidates that fall within the desired range of empathy scores are selected as being appropriate to being sent to the user in response to the request. This determination is made at least part on the empathy score of the particular candidates. In some examples, the system automatically selects at least 1 candidate in response to the request. In some examples, the system includes a maximum limit of candidates to be sent in response to request. In some examples, the system automatically selects a minimum number of candidates in response to the request. In some examples, the system automatically selects a minimum of 1 candidate. In some examples, the system automatically selects a maximum of 20 or fewer candidates. In some examples, the system automatically selects between 1 and 20 candidates, between 1 and 10 candidates, between 5 and 10 candidates, between 5 and 20 candidates, or other ranges between 1 and 20 candidates.

In some examples, the system determines an order in which the candidates are presented. In some examples, the candidates are presented in order of empathy scores highest to lowest. In alternative examples, candidates are presented based on ACE scores. In some examples, these candidates are presented in the rank from highest to lowest. In some examples, the candidates could first be selected based on a range of empathy scores, and then the candidates that fall within the range of empathy scores could be displayed in a random order, or in order from highest to lowest based on the candidate's ACE score.

In step 1205, in response to the request at 1201, and based on the steps performed in 1202-1204, the system automatically sends one or more audiovisual files to be displayed at the user's device. The audiovisual files correspond to candidate profiles from candidates whose empathy scores fall within a desired range. In some examples, the system sends only a portion of a selected candidate's audiovisual interview file to be displayed to the user.

In some examples, each candidate has more than one audiovisual interview files in the candidate profile. In this case, in some examples the system automatically selects one of the audiovisual interview files for the candidate. For example, if the candidate performed one video interview that was later segmented into multiple audiovisual interview files such that each audiovisual file contains an answer to a single question, the system can select a particular answer that is relevant to the request from the hiring manager, and send the audiovisual file corresponding to that portion of the audiovisual interview. In some examples, behavioral data recorded while the candidate was answering a particular question is used to select the audiovisual file to send to the hiring manager. For example, the system can select a particular question answered by the candidate in which the candidate expressed the greatest amount of empathy. In other examples, the system can select the particular question based on particular behaviors identified using the behavioral data, such as selecting the question based on whether the candidate was sitting upright, or ruling out the audiovisual files in which the candidate was slouching or fidgeting.

System and Method for Recording Behavioral Data Input (FIG. 27)

A system for recording behavioral data input, extracting behavioral data from the behavioral data input, and using the extracted behavioral data to determine an empathy score for candidate is presented in relation to FIGS. 27-29. The system uses data related to the candidate's body and torso movement to infer the candidate's level of empathy. Although one particular implementation of the system is described here, other implementations are possible and are within the scope of the disclosed technology.

FIG. 27 shows a method and system for recording behavioral data input. For ease of illustration, FIG. 27 shows the kiosk 101 from FIG. 1. It should be understood that other system set ups can be used to provide the same function, and the scope of the disclosed technology is not limited to this kiosk system. The system of FIG. 27 includes an enclosed booth 105, and houses multiple cameras 122, 124, 126 for recording video images of a candidate 112. As previously stated, each of the multiple cameras 122, 124, 126 can include a sensor for capturing video images, as well as an infrared depth sensor 1322, 1324, 1326 respectively, capable of sensing depth and movement of the individual.

In some examples, each of the cameras 122, 124, 126 is placed approximately one meter away from the candidate 112. In some examples, the sensor 1324 is a front-facing camera, and the two side sensors 1322 and 1326 are placed at an angle in relation to the sensor 1324. The angle can vary depending on the geometry needed to accurately measure the body posture of the candidate 112 during the video interview. In some examples, the sensors 1322, 1324, 1326 are placed at a known uniform height, forming a horizontal line that is parallel to the floor.

In some examples, the two side sensors 1322 and 1326 are angled approximately 45 degrees or less in relation to the front-facing sensor 1324. In some examples, the two side sensors 1322 and 1326 are angled 90 degrees or less in relation to the front-facing sensor 1324. In some examples, the two side sensors 1322 and 1326 are angled at least 20 degrees in relation to the front-facing sensor 1324. In some examples, the sensor 1322 can have a different angle with respect to the front-facing sensor 1324 than the sensor 1326. For example, the sensor 1322 could have an angle of approximately 45 degrees in relation to the front-facing sensor 1324, and the sensor 1326 could have an angle of approximately 20 degrees in relation to the front-facing sensor 1324.

In FIG. 27, dashed lines schematically represent the infrared sensors detecting the location of the candidate 112 within the space of the kiosk 101. The depth sensor emits infrared light and detects infrared light that is reflected. In some examples, the depth sensor captures an image that is 1,024 pixels wide and 1,024 pixels high. Each pixel detected by the depth sensor has an X, Y, and Z coordinate, but the pixel output is actually on a projection pane represented as a point (X, Y, 1). The value for Z (the depth, or distance from the sensor to the object reflecting light) can be calculated or mapped.

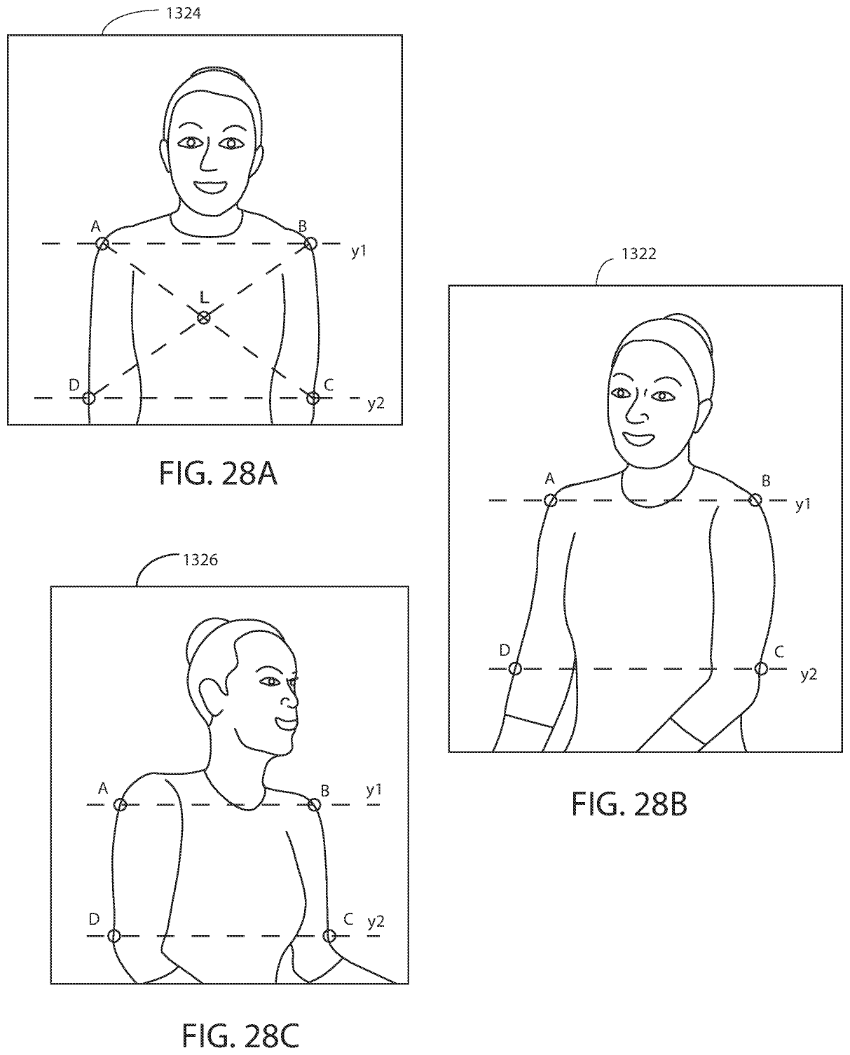

FIGS. 28A-28C show three images of a candidate 112 being recorded by the sensors in FIG. 27. It should be noted that the depth sensors would not pick up the amount of detail depicted in these figures, and these drawings are presented for ease of understanding. FIGS. 28A-C represent 1,024 by 1,024 pixel images detected by the depth sensor. With frame rates of 30 to 90 frames per second, the range of possible data points if each pixel were to be analyzed is between 217,000 and 1 million pixels. Instead of looking at every one of these pixels, the system instead selectively looks for the edge of the candidate's torso at four different points: the right shoulder (point A), the left shoulder (point B), the left waistline (point C), and the right waistline (point D). The infrared pixel data received by each sensor represents a grid of pixels each having an X value and a Y value. The system selects two Y values, y₁ and y₂, and looks only at pixels along those two horizontal lines. Therefore, the system only needs to take as input the pixels at points (xₙ, y₁) and (xₙ, y₂), where xₙ represents the values between x=1 and x=1,024.

Additionally, to limit the amount of pixel data that the system must analyze, the system does not search for these points in every frame captured by the sensors. Instead, because the individual's torso cannot move at a very high speed, it is sufficient to sample only a few frames per second. For example, the system could sample 5 frames per second, or as few as 2 frames per second, and discard the rest of the pixel data from the other frames.

Example of Determining Points A, B, C, and D

In FIG. 27, the sensor 1326 emits infrared light in a known pattern. The infrared light is reflected back after it hits an object. This reflected light is detected by the sensor 1326 and is saved as a grid of pixels. In FIG. 27, infrared light emitted from sensor 1326 along the line 1336 hits the edge of the candidate 112's shoulder and is reflected back. Infrared light emitted from sensor 1326 along the line 1346 hits the back wall of the kiosk 101 and is reflected back. The light that traverses the lines 1336 and 1346 are saved as separate pixels. The pixels have X values and Y values. The system can calculate the Z values corresponding to the distance of the object from the sensor. In this example, the system determines that the Z value for the pixel projected along line 1336 is significantly smaller than the Z value for the pixel projection along line 1346. The system then infers that this point marks the edge of the individual's torso. In FIG. 28C, the system designates this point as point A on the individual's right shoulder. The system samples additional pixels along the line Y=y₁, and similarly determines that the pixel projected along line 1337 marks the other edge of the individual's torso. The system designates this point as point B on the individual's left shoulder.

The system then repeats this process for the line of pixels at Y=y₂ in a similar manner. The system marks the edge of the individual's torso on the left and right sides as points C and D respectively. The system performs similar operations for each of the sensors 1322 and 1324, and finds values for points A, B, C, and D for each of those frames.

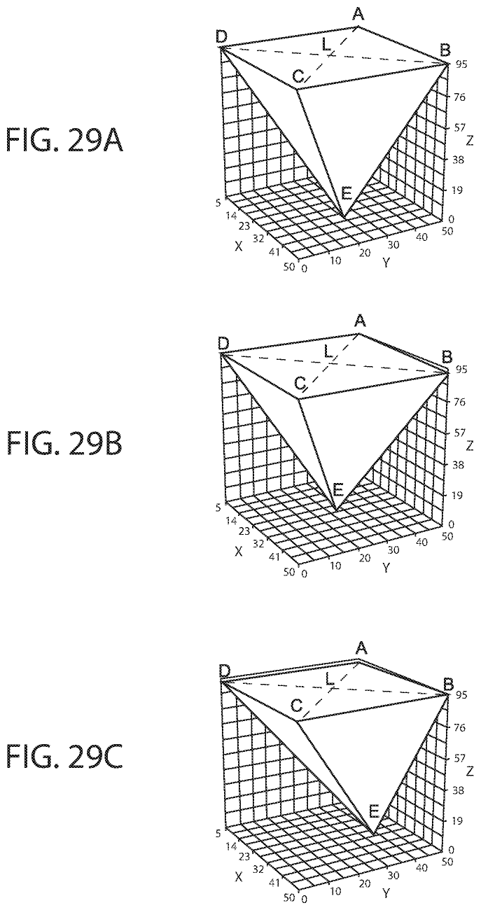

The system designates the location of the camera as point E. Points A, B, C, D, and E can be visualized as a pyramid having a parallelogram shaped base ABCD and an apex at point E, as seen in FIGS. 29A-C. FIG. 29A represents the output of the calculation in FIG. 28A, FIG. 29B represents the output of the calculation in FIG. 28B, and FIG. 29C represents the output of the calculation in FIG. 28C. Point L is designated as the intersection between lines A̅C̅ and B̅D̅. The length of line E̅L̅ represents approximately the distance of the center of the individual's torso to the sensor.

The system stores at least the following data, which will be referred to here as “posture volumes data”: the time stamp at which the frame was recorded; the coordinates of points A, B, C, D, E, and L; the volume of the pyramid ABCDE; and the length of line E̅L̅. In practice, simple loops can be programmed to make these calculations on-the-fly. Because the sensor data being analyzed by the system is a very small subset of all of the available sensor data, the system is capable of performing this analysis in real time while the individual is being recorded with audio and video.

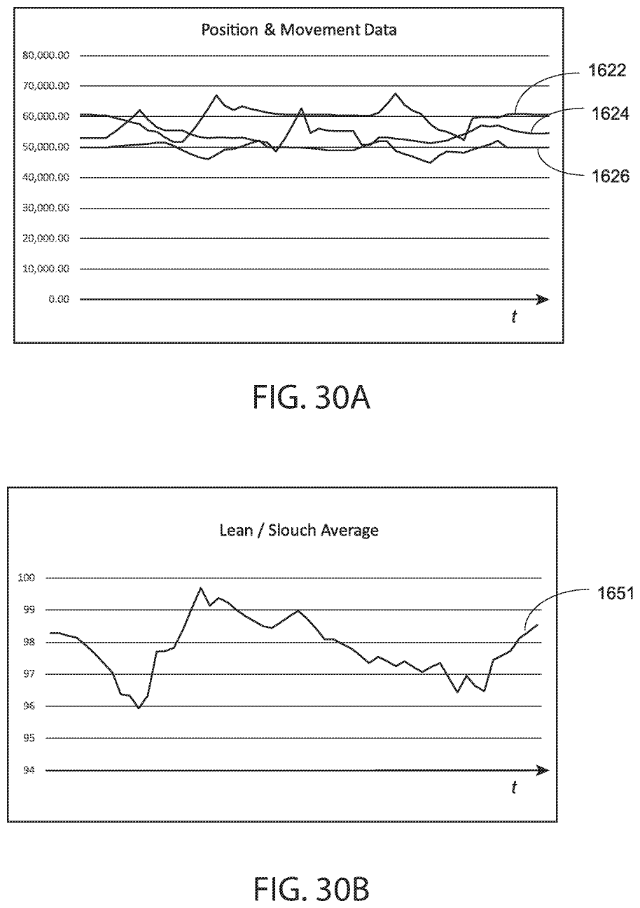

A further advantage is that the sensor data, being recorded simultaneously with the audio and video of the candidate's interview, can be time synchronized with the content of the audio and video. This allows the system to track precisely what the individual's torso movements were during any particular point of time in the audiovisual file. As will be shown in relation to FIGS. 30A-B, the posture volumes data can be represented as a graph with time on one axis and the posture volumes data on a second axis. A person viewing the graph can visually analyze the changes in the individual's torso, and jump immediately to the audio and video of that portion of the interview.

Graphing Extracted Behavioral Data (FIGS. 30A-B)

Some movements by the candidate can correspond to whether a candidate is comfortable or uncomfortable during the interview. Some movements indicate engagement with what the candidate is saying, while other movements can reflect that a candidate is being insincere or rehearsed. These types of motions include leaning into the camera or leaning away from the camera; moving slowly and deliberately or moving with random movements; or having a lower or higher frequency of body movement. The candidate's use of hand gestures can also convey information about the candidate's comfort level and sincerity. The system can use the movement data from a single candidate over the course of an interview to analyze which question during the interview the candidate is most comfortable answering. The system can use that information to draw valuable insights about the candidate. For example, if the movement data indicates that the candidate is most comfortable during a question about their background, the system may deduce that the candidate is likely a good communicator. If the movement data indicates that the candidate is most comfortable during a question about their advanced skills or how to provide care in a particular situation, the system may deduce that the candidate is likely a highly-skilled candidate.

In one aspect, the system can generate a graph showing the candidate's movements over the course of the interview. One axis of the graph can be labeled with the different question numbers, question text, or a summary of the question. The other axis of the graph can be labeled with an indicator of the candidate's movement, such as leaning in versus leaning out, frequency of movement, size of movement, or a combination of these.

In one aspect, in addition or alternatively, the system can select which portion of the candidate interview to show to a user based on the movement data. The portion of the interview that best highlights the candidate's strengths can be selected. In addition or alternatively, a user can use a graph of movement of a particular candidate to decide which parts of an interview to view. The user can decide which parts of the interview to watch based on the movement data graphed by question. For example, the user might choose to watch the part of the video where the candidate showed the most movement or the least movement. Hiring managers often need to review large quantities of candidate information. Such a system allows a user to fast forward to the parts of a candidate video that the user finds most insightful, thereby saving time.

Users can access one particular piece of data based on information known about another piece of data. For example, the system is capable of producing different graphs of the individual's torso movement over time. By viewing these graphs, one can identify particular times at which the individual was moving a lot, or not moving. A user can then request to view the audiovisual file for that particular moment.

FIGS. 30A and 30B show two examples of graphs that can be created from behavioral data gathered during the candidate video interview. A human viewer can quickly view these graphs to determine when the candidate was comfortable during a question, or when the candidate was fidgeting. With this tool, a hiring manager can look at the graph before viewing the video interview and select a particular time in the timeline that the hiring manager is interested in seeing. This allows the hiring manager to efficiently pick and choose which portions of the video interviews to watch, saving time and energy.

FIG. 30A shows an example of a graph of data from among the posture volume data described above. In particular, FIG. 30A graphs the volume of the pyramid ABCDE from FIGS. 29A-C as the volume changes over time. The line 1622 represents volume data collected from sensor 1322 versus time, the line 1624 represents volume data collected from sensor 1324 versus time, and the line 1626 represents volume data collected from sensor 1326 versus time. These lines correspond to movement in the individual's torso during the video interview.

Reading the graph in 30A allows a user to see what the candidate's motion was like during the interview. When the individual turns away from a sensor, the body becomes more in profile, which means that the area of the base of the pyramid becomes smaller and the total volume of the pyramid become smaller. When the person turns toward a sensor, the torso becomes more straight on to the camera, which means that the area of the base of the pyramid becomes larger. When the line for the particular sensor is unchanged over a particular amount of time, it can be inferred that the individual's torso was not moving.

FIG. 30 B is a graph showing the individual's distance from the camera to the “center of mass lean,” defined as the average value of the length of lines EL for the pyramids calculated for sensors 1322, 1324, 1326. From this simple graph, we might infer that the candidate felt particularly strongly about what they were saying because they leaned into the camera at that moment, or that they wished to create distance from their statements at times when they leaned away from the camera. In FIG. 30B, the line 1651 represents whether the individual is leaning in toward the camera or leaning away from the camera. When the value L is large, the individual can be inferred to be leaning in toward the camera. When the value L is small, the individual can be inferred to be leaning away from the camera, or slouching.

Method of Evaluating an Individual Based on a Baseline Measurement for the Individual

In some examples, the system uses movement data in one segment of a candidate's video interview to evaluate the candidate's performance in a different part of the video interview. Comparing the candidate to themselves from one question to another provides valuable insight and does not need a large pool of candidates or computer-intensive analysis to analyze the movement of a large population.

In one aspect, the candidate's body posture and body motion are evaluated at the beginning of the interview, for example over the course of answering the first question. This measurement is used as a baseline, and the performance of the candidate during the interview is judged against the performance during the first interview question. This can be used to determine the portion of the interview in which the candidate feels the most comfortable. The system can then prioritize the use of that particular portion of the interview to show to hiring managers. Other uses could include deciding which portions of the behavioral data to use when calculating an empathy score for the candidate.

In this aspect, the system takes a first measurement of the individual at a first time. For example, the system could record posture data and calculate posture volume data for the candidate over the time period in which the candidate was answering the first interview question. This data can be analyzed to determine particular characteristics that the individual showed, such as the amount that the volume changed over time, corresponding to a large amount or small amount of motion. The system can also analyze the data to determine the frequency of volume changes. Quick, erratic volume changes can indicate different empathy traits versus slow, smooth volume changes. This analysis is then set as a baseline against which the other portions of the interview will be compared.

The system then takes a second measurement of the individual at a second time. This data is of the same type that was measured during the first time period. The system analyzes the data from the second time period in the same manner that the first data was analyzed. The analysis of the second data is then compared to the analysis of the first data to see whether there were significant changes between the two. This comparison can be used to determine which questions the candidate answered the best and where the candidate was most comfortable speaking. This information then can be used to select which portion of the video interview to send to a hiring manager.

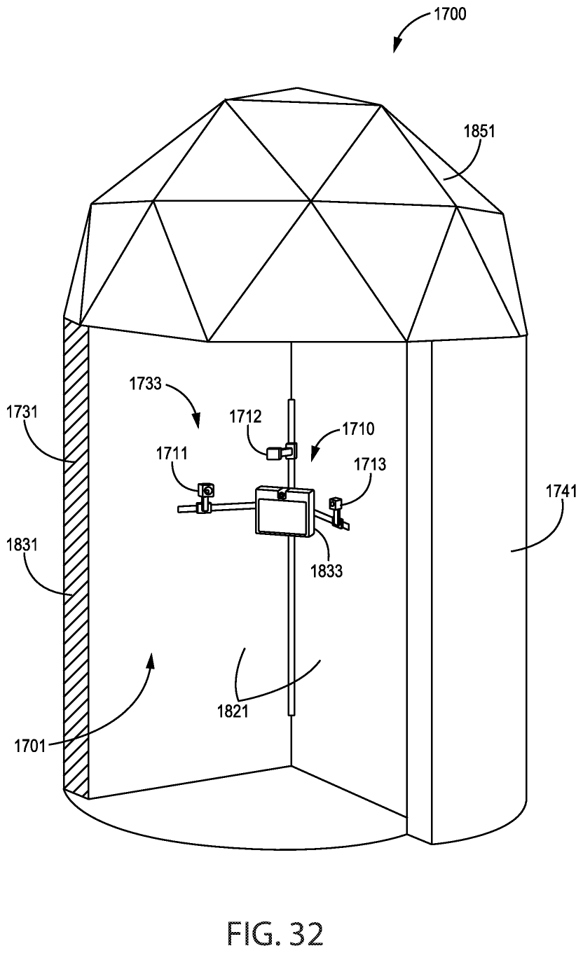

Multi-Camera Kiosk with Multiple Camera Studios (FIGS. 31-32)

FIGS. 31 and 32 show an alternative example of a kiosk that is compatible with the present disclosure. A multi-studio kiosk 1700 has multiple studios in a single booth, which allows multiple candidates to be recorded simultaneously. Kiosk 1700 includes a first studio 1701, a second studio 1702, and a third studio 1703. Each of the studios is an enclosed, soundproof booth configured to record video interviews. In the example of FIG. 31, each of the studios is configured in a similar manner. In alternative examples, each studio could be configured for a custom purpose, with different camera arrangements or different booth design, etc. Furthermore, although three studios are shown, it should be understood that the kiosk could be divided into different studios in a number of different ways, and could have more or fewer than three studios.

The studios include a multi-camera array 1710 that includes a first camera 1711, a second camera 1712, and a third camera 1713. Although the multi-camera array 1710 is shown with three cameras, it should be understood that the system can be used with more or fewer than three cameras. Each studio in the kiosk 1700 also includes one or more microphones and one or more behavioral data sensors for capturing movement and other behavioral data of the candidate during the video interview. For example, each of the cameras 1711, 1712, 1713 can have both an image sensor for capturing video images and an infrared sensor for capturing motion and depth. A user interface 1833 can be provided for prompting the candidate to answer questions.

In some examples the studios include seating 1725, which could be a moveable or fixed chair. In some examples, the seat 1725 can be removed from the studio to allow the studio to be wheelchair accessible, or to allow candidates to stand during the video interview. A server storage area 1750 can be provided in the space between the three studios to store electronic components of the system, such as the edge server.

Turning to FIG. 32, the kiosk 1700 includes soundproof walls 1731 with sound proofing material 1831. In some examples, the soundproofing material 1831 is sandwiched between two fiberglass skins that form the walls 1731. FIG. 32 is shown with one of the walls 1731 partially cut away to show the soundproofing 1831 inside. In some examples, the kiosk 1700 has an inside diameter of approximately 12 feet (3.6 meters) with 4 inches (10.1 centimeters) of soundproofing material 1831 in the walls, making the overall outside diameter of the kiosk 12 feet 8 inches (3.86 meters). The drawing in FIG. 32 is not drawn to scale. In a kiosk with three equal size studios and an inner diameter of 12 feet (3.6 meters), each studio has a floor space of approximately 37 square feet (3.44 square meters).

In some examples, the kiosk 1700 is covered with a dome 1851 that forms a roof of the kiosk 1700. For example, the dome can be a Kruschke 3v 4/9 dome having 75 triangular panels. In alternative examples, a flat cover can be provided for the roof of the kiosk 1700. Other alternatives are possible, and are within the scope of the present disclosure. In some examples, the kiosk is provided without a roof.

Each of the studios 1701, 1702, 1703 can be separated from the other two studios by a soundproofed divider 1733. The interior walls 1821 of the dividers 1733 can be covered with a sound dampening material to prevent excess reverberation inside the booth from compromising the recorded audio quality. The interior roof of the studio 1701 can also be covered with a sound dampening material.

Each studio 1701, 1702, 1703 includes a sliding door 1741. In the example of FIGS. 31 and 32, the sliding doors 1741 are configured to conform to the contours of the side walls of the kiosk 1700. The sliding door 1741 can be hung on a double track to keep the door concentric to the outside wall 1731. In some examples, the opening of the door 1741 is at least 42 inches (approximately 1 meter) or wider to comply with federal regulations. The doors 1741 can also include soundproofing inside the thickness of the door to further protect each studio from exposure to outside noise.

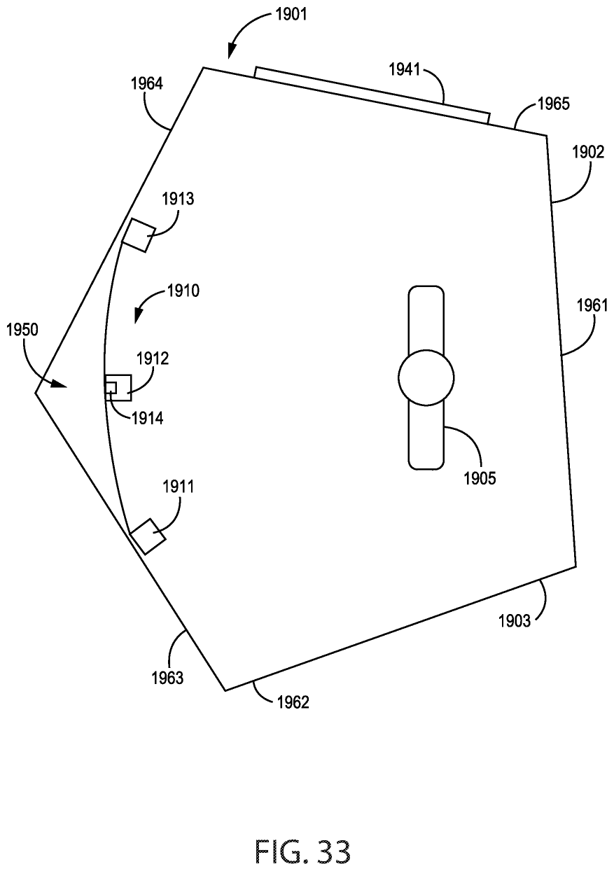

Portable Multi-Camera Kiosk (FIG. 33)

FIG. 33 shows an example of an alternative kiosk configuration. The portable kiosk 1901 is an enclosed booth 1902 with soundproofed walls 1903. The kiosk 1901 houses a multi-camera array 1910 including multiple cameras 1911, 1912, 1913 for recording a video interview of a candidate 1905. A microphone 1914 can also be provided a server storage area 1950 can optionally be placed behind the multi-camera array 1910. The interior of the enclosed booth 1902 is accessible via a door 1941.

In the example of FIG. 33, the enclosed booth 1902 has five straight sides that create a pentagonal footprint. The walls can be constructed from canvas covered foam. Four of the walls 1961, 1962, 1963, and 1964 can be a connected structure that folds down into a stack for easy transport. The wall 1965 contains an opening for the door 1941. This can be connected to the other walls using hook and loop fasteners, snaps, or other temporary fastening devices. Each of the walls contains soundproofing. In some examples, each of the walls contains up to two inches of soundproofing material. The weight and bulk of the soundproofing material will affect the portability of the kiosk, and some trade-offs may need to be made between quality of soundproofing and portability of the kiosk 1901. Additionally, the size of the kiosk footprint is constrained based on desired portability. In some examples, each of the sidewalls is at least five feet wide. This size provides enough room for the system to use three different cameras to capture the video interview from three different perspectives. In some examples, the sidewalls are greater than 5 feet (1.5 meters) wide. The kiosk can have sidewalls of at least 6 feet (1.8 meters) in width, which provides additional area, making the kiosk more accessible.

Geometry of Multi-Camera Array and Kiosk Footprint

In the various examples described herein, the layout of the kiosk can be optimized to record interesting and engaging video interviews using multiple video cameras. FIG. 33 illustrates one example of the geometry of the kiosk layout. If the kiosk 1901 is pentagonally shaped with walls approximately 5 feet (1.5 meters) wide, the total floor area of the kiosk is approximately 42 feet squared (3.87 meters squared). If the kiosk walls are approximately 6 feet (1.8 meters) wide, the total floor area of the kiosk is approximately 60 feet squared (5.57 meters squared). In the example of FIG. 31, in which a three-studio kiosk has an inner diameter of 12 feet (3.6 meters), each studio has a floor space of approximately 37 square feet (3.44 square meters). Other sizes and shapes are contemplated, and are within the scope of the technology.

In the example of FIG. 33, each of the cameras 1911, 1912, 1913 can be placed approximately one meter away from the candidate 1905. The focal length and lenses of the camera can be optimized to work within the space afforded by the kiosk. In some examples, the camera 1912 is a front-facing camera, and the two side cameras 1911 and 1913 are placed at an angle, which can vary depending on the desired final look of the video interview. In some examples, the two side cameras 1911 and 1913 are angled approximately 45 degrees or less in relation to the front-facing camera 1912. In some examples, the two side cameras 1911 and 1913 are angled 90 degrees or less in relation to the front-facing camera 1912. In some examples, the two side cameras 1911 and 1913 are angled at least 20 degrees in relation to the front-facing camera 1912. In some examples, the camera 1911 can have a different angle with respect to the front-facing camera 1912 than the camera 1913. For example, the camera 1911 could have an angle of approximately 45 degrees in relation to the front-facing camera 1912, and the camera 1913 could have an angle of approximately 20 degrees in relation to the front-facing camera 1912.

In some examples, the height of the cameras 1911, 1912, 1913 is adjustable. The distance between each of the cameras 1911, 1912, 1913 can also be adjustable. In some examples, the cameras are placed on a track, and can be moved horizontally as desired. In some examples, the cameras can be pivoted to the left or right as desired to optimally focus on the candidate 1905. The cameras can also be provided with a zoom feature that can be controlled manually or automatically to adjust the zoom of one or more of the three cameras. Although particular examples have been described here, it should be understood that alternative set ups of the multi-camera kiosk are contemplated, and are within the scope of the disclosed technology.

Construction and Soundproofing Materials

In the various examples provided herein, the kiosk comprises rigid outer walls that have soundproofing features. In some examples, such as the pentagonal kiosk design in FIG. 33, the kiosk walls can be fabric wrapped acoustic panels. The acoustic panels can contain a glass mineral wool core that provides noise reduction. In one example, the panels include acrylic. In one example, the panels include polycarbonate. In one example, the panels define an air gap between layers of the panel. In one example, the panels include layers of PVB, glass, and an air gap. In one example, the panels can include a gas-inflated bladder between two transparent, planar sheets, as illustrated in FIGS. 10-15. Such panels are available commercially as AirHush® from ISAT Systems, Inc., having a location at San Francisco, Calif.

In another example, the walls of the kiosk can be constructed from panels sold by Total Security Solutions, having a location in Fowlerville, Mich., USA, under the product name Level One AR acrylic sheets. These panels have a UL Level 1 ballistic rating to withstand rounds from small caliber handguns, such as a 9-millimeter handgun, and are transparent, providing light transmission of 90% or greater.

It is also possible for the panels to be opaque and provide privacy to the occupant of the kiosk.

The panels can be wrapped with acoustic fabric that prevents audio distortion within the booth itself. A cylindrical kiosk can be formed from two concentric fiberglass shells, such as those used in grain silos. A soundproofing material can be provided between the two fiberglass shells.

As used in this specification and the appended claims, the singular forms include the plural unless the context clearly dictates otherwise. The term “or” is generally employed in the sense of “and/or” unless the content clearly dictates otherwise. The phrase “configured” describes a system, apparatus, or other structure that is constructed or configured to perform a particular task or adopt a particular configuration. The term “configured” can be used interchangeably with other similar terms such as arranged, constructed, manufactured, and the like.

All publications and patent applications referenced in this specification are herein incorporated by reference for all purposes.

While examples of the technology described herein are susceptible to various modifications and alternative forms, specifics thereof have been shown by way of example and drawings. It should be understood, however, that the scope herein is not limited to the particular examples described. On the contrary, the intention is to cover modifications, equivalents, and alternatives falling within the spirit and scope herein.

1. A kiosk comprising:
a. a booth comprising:
i. an enclosing wall forming a perimeter of the booth and defining a booth interior;
1. wherein the enclosing wall extends between a bottom of the enclosing wall and a top of the enclosing wall;
2. wherein the enclosing wall comprises: a front wall, a back wall, a first side wall, and a second side wall;
3. wherein the front wall is substantially parallel with the back wall, and the first side wall is substantially parallel with the second side wall,
4. wherein the first side wall and the second side wall extend from the front wall to the back wall;
5. wherein the enclosing wall has a height from the bottom of the enclosing wall to the top of the enclosing wall of at least 7 feet (2.1 meters) and not more than 13 feet (4.0 meters);
6. wherein the perimeter is at least 14 feet (4.3 meters) and not more than 80 feet (24.4 meters);
ii. a first camera, a second camera, and a third camera for taking video images, each of the cameras aimed proximally toward the booth interior;
1. wherein the first camera, the second camera, and the third camera are disposed at a height of at least 30 inches (76 centimeters) and not more than 70 inches (178 centimeters) from the bottom of the enclosing wall;
2. wherein the first camera, the second camera, and the third camera are disposed adjacent to the front wall;
iii. a first microphone for receiving sound in the booth interior, wherein the microphone is disposed within the booth interior;
iv. a first depth sensor and a second depth sensor for capturing behavioral data,
1. wherein the first depth sensor is disposed at a height of at least 20 inches (51 centimeters) and not more than 45 inches (114 centimeters) from the bottom of the enclosing wall;
2. wherein the second depth sensor is disposed at a height of at least 30 inches (76 centimeters) and not more than 50 inches (127 centimeters) from the bottom of the enclosing wall;
3. wherein the first depth sensor and the second depth sensor are aimed proximally toward the booth interior;
4. wherein the first depth sensor is mounted on the first side wall or on the second side wall, and the second depth sensor is mounted on the back wall.
v. a first user interface shows a video of a user, prompts the user to answer interview questions, or prompts the user to demonstrate a skill,
b. an edge server connected to the first camera, the second camera, the third camera, the first depth sensor, the second depth sensor, the first microphone, and the first user interface.

2. The kiosk of claim 1, wherein the first camera, the second camera, and the third camera are mounted to the front wall, or wherein the first camera is mounted to the first side wall, the second camera is mounted to the front wall, and the third camera is mounted to the second side wall.

3. The kiosk of claim 1, further comprising a fourth camera disposed adjacent to or in the corner of the front wall and the second side wall;
wherein the first side wall comprises a door;
wherein the fourth camera is disposed at a height of at least 50 inches (127 centimeters) from the bottom of the enclosing wall.

4. The kiosk of claim 3, further comprising a fifth camera disposed adjacent to or in the corner of the back wall and the second side wall, wherein the fifth camera is disposed at a height of at least 50 inches (127 centimeters) from the bottom of the enclosing wall.

5. The kiosk of claim 1, further comprising a second user interface and a third user interface, wherein the second user interface is mounted on a first arm extending from the second side wall and the third user interface is mounted on a second arm extending from the first side wall.

6. The kiosk of claim 5, wherein the first user interface is configured to display an image of the user, the second user interface is configured to receive input for the user in response to a prompt provided by the third user interface, and the third user interface is configured to provide a prompt to the user.

7. The kiosk of claim 1, wherein the kiosk does not include a roof connected to the enclosing wall.

8. The kiosk of claim 1, further comprising a third depth sensor for capturing behavioral data, wherein the third depth sensor is mounted on the first side wall or the second side wall opposite from the first depth sensor;
wherein the third depth sensor is disposed at a height of at least 30 inches (76 centimeters) and not more than 50 inches (127 centimeters) from the bottom of the enclosing wall;
wherein the third depth sensor is aimed proximally toward the booth interior;
wherein the edge server is connected to the third depth sensor.

9. A kiosk comprising:
a. a booth comprising:
i. an enclosing wall forming a perimeter of the booth and defining a booth interior;
A. wherein the enclosing wall extends between a bottom of the enclosing wall and a top of the closing wall;
B. wherein the enclosing wall has a height from the bottom of the enclosing wall to the top of the enclosing wall of at least 7 feet (2.1 meters) and not more than 13 feet (4.0 meters);
C. wherein the perimeter is at least 14 feet (4.3 meters) and not more than 80 feet (24.4 meters);
ii. a first camera and a second camera for taking video images, each of the cameras aimed proximally toward the booth interior;
A. wherein the first camera and the second camera are disposed at a height of at least 30 inches (76 centimeters) and not more than 70 inches (178 centimeters) from the bottom of the enclosing wall;
B. wherein the first camera and second camera are disposed on the same portion of the enclosing wall;
iii. a first microphone for receiving sound in the booth interior;
iv. at least one depth sensor for capturing behavioral data,
A. wherein the at least one depth sensor is disposed at a height of at least 20 inches (51 centimeters) and not more than 50 inches (127 centimeters) from the bottom of the enclosing wall;
B. wherein the at least one depth sensor is aimed proximally toward the booth interior;
v. a user interface that shows a video of a user, prompts the user to answer interview questions, or prompts the user demonstrate a skill,
wherein the user interface comprises a third camera;
b. an edge server connected to the first camera, the second camera, the depth sensor, the first microphone, and the user interface.

10. The kiosk of claim 9, wherein the enclosing wall comprises an extruded metal frame and polycarbonate panels.

11. The kiosk of claim 9, wherein the depth sensor comprises a stereoscopic depth sensor.

12. The kiosk of claim 9, further comprising an occupancy sensor disposed in a corner of the booth at a height of at least 72 inches (183 centimeters) from the bottom of the enclosing wall.

13. The kiosk of claim 12, wherein the occupancy sensor comprises an infrared camera.

14. The kiosk of claim 9, further comprising a fourth camera for taking video images, the fourth camera aimed proximally toward the booth interior.

15. The kiosk of claim 14, wherein the fourth camera is disposed at a height of at least 30 inches (76 centimeters) and not more than 70 inches (178 centimeters) from the bottom of the enclosing wall;
wherein the fourth camera is disposed on the same portion of the enclosing wall as the first camera and the second camera.

16. A kiosk comprising:
a. a booth comprising:
i. an enclosing wall forming a perimeter of the booth and defining a booth interior, wherein the enclosing wall extends between a bottom of the enclosing wall and a top of the enclosing wall;
ii. a first camera and a second camera for taking video images, each of the cameras aimed proximally toward a user in the booth interior;
iii. a first microphone for receiving sound in the booth interior;
iv. at least one depth sensor for capturing behavioral data,
v. a user interface that prompts the user to answer interview questions or demonstrate a skill;
b. an edge server connected to the first camera, the second camera, the depth sensor, and the first microphone, the edge server comprising:
i. a time counter providing a timeline associated with the capturing of video images from the first and second cameras, the capturing of behavioral data from the depth sensor, and the capturing of audio from the first microphone, wherein the timeline enables a time synchronization of the video images, the behavioral data, and the audio; and
ii. a non-transitory computer memory and a computer processor in data communication with the first and second cameras and the first microphone; and
c. computer instructions stored on the memory for instructing the processor to perform the steps of:
i. capturing first video input of the user from the first camera,
ii. capturing second video input of the user from the second camera,
iii. capturing behavioral data input from the depth sensor,
iv. capturing audio input of the user from the first microphone,
v. aligning the first video input, the second video input, the behavioral data, and the audio input with the time counter,
vi. extracting behavioral data from the behavioral data input, and
vii. associating a prompted question or demonstration of a skill with the extracted behavioral data.

17. The kiosk of claim 16, wherein the computer instructions stored on the memory for instructing the processor to further perform the steps of:
i. automatically concatenating a portion of the first captured video data and a portion of the second captured video data, and
ii. automatically saving the concatenated video data with the audio data as a single audiovisual file.

18. The kiosk of claim 17, further comprising a second microphone for capturing audio housed in the enclosed booth,
wherein the edge server is connected to the second microphone, and the time counter provides a timeline further associated with the second microphone;
wherein the computer instructions stored on the memory for instructing the processor to further perform the steps of:
i. analyzing audio from the first microphone and audio from the second microphone to determine the highest quality audio data;
ii. automatically saving the concatenated video data with the highest quality audio data as a single audiovisual file.

19. The kiosk of claim 18, wherein the highest quality audio data is determined by determining which audio has the highest volume.

20. The kiosk of claim 18, wherein the highest quality audio data is determined by determining which audio has the lowest signal to noise ratio.

21. The kiosk of claim 17, wherein the single audiovisual file comprises video input from the first camera when audio from the first microphone is used and video input from the second camera when audio from the second microphone is used.

22. The kiosk of claim 16, further comprising computer instructions stored on the memory for instructing the processor to, when associating the prompted question or demonstration of the skill with extracted behavioral data, process the audio data with speech to text analysis and compare a subject matter in the audio data to a behavioral characteristic.

23. The kiosk of claim 22, wherein the behavioral characteristic includes a characteristic selected from the group consisting of sincerity, empathy, and comfort.

24. The kiosk of claim 16, wherein the depth sensor includes a sensor selected from the group consisting of an optical sensor, an infrared sensor, and a laser sensor

25. The kiosk of claim 16, wherein the kiosk further comprises a second user interface separate from the first user interface, wherein the second user interface is configured for the user to input data in response to the prompt to demonstrate a skill.

26. The kiosk of claim 25, wherein the second user interface is disposed opposite from or adjacent to the first user interface.

27. The kiosk of claim 25, wherein computer instructions stored on the memory for instructing the processor to further perform the step of: aligning the input from the second user interface with the first video input, the second video input, the behavioral data, and the audio input with the time counter.
